(19) United States
(12) Patent Application Publication
(10) Pub. No.: US 2026/0228355 A1
(43) Pub. Date: Aug. 6, 2026

(54) TRUSTWORTHY STATE INDICATION AND CONTROL SYSTEMS FOR DIGITAL SENSING SYSTEMS

(71) Applicant: University of Washington, Seattle, WA (US)

(72) Inventors: James Pierce, Seattle, WA (US); Robyn Anderson, Seattle, WA (US)

(73) Assignee: University of Washington, Seattle, WA (US)

(21) Appl. No.: 19/458,398

(22) Filed: Jan. 23, 2026

Related U.S. Application Data
(60) Provisional application No. 63/750,706, filed on Jan. 28, 2025.

(51) Int. Cl. G06F 21/62; G08B 5/36; H04N 7/18

(52) U.S. Cl. CPC G06F 21/6218; G08B 5/36; H04N 7/183

(57) ABSTRACT

The present disclosure provides a sensing device comprising a camera to capture sensor data, a user-perceptible indicator that indicates to a user a current privacy mode from a plurality of privacy modes, and a processor to process the sensor data based on the current privacy mode. The plurality of privacy modes includes at least a True On mode in which all sensing capabilities are active, a True Off mode in which no sensing capabilities are active, and at least one intermediate privacy mode in which a subset of sensing capabilities are active.

### CROSS-REFERENCE TO RELATED APPLICATIONS

This application claims the benefit of U.S. provisional Ser. No. 63/750,706, filed Jan. 28, 2025, titled “Trustworthy And Inclusive State Indication And Control Systems For Digital Sensing Systems” which is incorporated herein by reference.

### STATEMENT REGARDING FEDERALLY SPONSORED RESEARCH

This invention was made with government support under Grant Nos. 1910218 and 2142795, awarded by the National Science Foundation (NSF). The government has certain rights in the invention.

### FIELD OF INVENTION

The present disclosure relates to state indication and control systems for digital sensing systems, and more particularly to a privacy-enhancing smart camera system with adjustable sensing modes and user-configurable access controls.

### BACKGROUND

Digital sensing systems such as smart home cameras have become increasingly prevalent in recent years, offering users the ability to monitor their homes remotely for security and convenience. These devices typically incorporate high-resolution video cameras, microphones, motion sensors, and network connectivity to capture and transmit data. Many smart cameras also leverage cloud computing and artificial intelligence (AI) capabilities to provide advanced features like facial recognition, object detection, and automated alerts.

While smart home cameras offer numerous benefits, they also raise significant privacy concerns. The always-on nature of these devices means they are constantly capturing video and audio data within people's homes. This data may include sensitive information about residents and visitors, including their movements, conversations, and daily routines. There are risks associated with this data being accessed by unauthorized parties through hacking or data breaches. Additionally, even authorized uses of smart camera data by device manufacturers or third-party services may make some users uncomfortable.

Current smart camera systems typically offer limited privacy controls, often restricted to simply turning the camera on or off. More granular privacy settings or the ability to customize data capture based on different contexts are generally lacking. There is also often a lack of transparency around when cameras are actively recording or transmitting data. This can create uncertainty for both primary users of the devices as well as other household members, guests, and neighbors who may be captured by the cameras.

As smart home cameras continue to proliferate, there is a growing need for more robust privacy protections and user controls. Ideally, these systems should balance the useful functionality of smart cameras with mechanisms to preserve privacy and give users greater control over their data.

### BRIEF DESCRIPTION OF FIGURES

Non-limiting and non-exhaustive examples are described with reference to the following figures.

FIG. 1 depicts an example implementation of a camera unit 100 in a True On state, in accordance with various embodiments.

FIG. 2 depicts an example user interface (UI) display 200 consistent with FIG. 1, in accordance with various embodiments.

FIG. 3 depicts an example implementation of the camera unit 100 in a True Off state, in accordance with various embodiments.

FIG. 4 depicts an example UI 400 consistent with FIG. 3, in accordance with various embodiments.

FIG. 5 depicts an example implementation of the camera unit 100 in a medium privacy state, in accordance with various embodiments.

FIG. 6 depicts an example UI 600 consistent with FIG. 5, in accordance with various embodiment.

FIG. 7 depicts an example implementation of the camera unit 100 in a strong privacy state, in accordance with various embodiments.

FIG. 8 depicts an example UI 800 consistent with FIG. 7, in accordance with various embodiment.

FIG. 9 depicts an example image 900 from a camera in which a face is detected in a region 910, as an example of an event consistent with FIG. 8, in accordance with various embodiments.

FIG. 10 depicts an example implementation of a ring-shaped privacy indicator 1000 around the camera lens 120, correspond to a minimum level of privacy, in accordance with various embodiments.

FIG. 11 depicts an example implementation of an arc-shaped privacy indicator 1100 around the camera lens 120, correspond to a medium-low level of privacy, in accordance with various embodiments.

FIG. 12 depicts an example implementation of an arc-shaped privacy indicator 1200 around the camera lens 120, correspond to a medium level of privacy, in accordance with various embodiments.

FIG. 13 depicts an example implementation of an arc-shaped privacy indicator 1300 around the camera lens 120, correspond to a strong level of privacy, in accordance with various embodiments.

FIG. 14 depicts an example implementation of an arc-shaped privacy indicator 1400 around the camera lens 120, correspond to a high level of privacy, in accordance with various embodiments.

FIG. 15 depicts an example implementation of a bar-shaped privacy indicator 1500 correspond to a minimum level of privacy, in accordance with various embodiments.

FIG. 16 depicts an example implementation of a bar-shaped privacy indicator 1600 correspond to a medium level of privacy, in accordance with various embodiments.

FIG. 17 depicts an example implementation of a bar-shaped privacy indicator 1700 correspond to a strong level of privacy, in accordance with various embodiments.

FIG. 18 depicts an example implementation of a lens cover as a privacy indicator 1800 correspond to a maximum level of privacy, in accordance with various embodiments.

FIG. 19 depicts an example implementation of three point lights 1900 as a privacy indicator, where the lights are all yellow (shown by a lighter shade of grey), corresponding to a minimum level of privacy, in accordance with various embodiments.

FIG. 20 depicts an example implementation of three point lights 1900 as a privacy indicator, where the edge lights are yellow and the middle light is red (shown by a darker shade of grey), corresponding to a medium level of privacy, in accordance with various embodiments.

FIG. 21 depicts an example implementation of three point lights 1900 as a privacy indicator, where the middle light is yellow and the edge lights are red, corresponding to a strong level of privacy, in accordance with various embodiments.

FIG. 22 depicts an example implementation of three point lights 1900 as a privacy indicator, where the lights are red, corresponding to a maximum level of privacy, in accordance with various embodiments.

FIG. 23 depicts an example of a sensor overlay 2300 as a light-blocking lens cover, in accordance with various embodiments.

FIG. 24 depicts an example of a sensor overlay 2400 as a light filter, in accordance with various embodiments.

FIG. 25 depicts another example of a sensor overlay 2500 as a light filter, in accordance with various embodiments.

FIG. 26A depicts a front view of an electrophoretic overlay 2600 for the camera lens 120, in accordance with various embodiments.

FIG. 26B depicts a side view of the electrophoretic overlay 2600 and the camera lens 120 of FIG. 26A, in accordance with various embodiments.

FIG. 27 depicts an example of a robot 2700 having a privacy indicator 2740, in accordance with various embodiments.

FIG. 28 depicts an example of smart glasses 2800 having a privacy indicator 2810 in accordance with various embodiments.

FIG. 29 depicts an example of a wearable device 2900 having a privacy indicator 2910, in accordance with various embodiments.

FIG. 30 depicts an example of a movable camera 3000 having a privacy indicator 3010, in accordance with various embodiments.

FIG. 31A depicts an example block diagram of an architecture of a camera unit 3100, in accordance with various embodiments.

FIG. 31B depicts an example block diagram of an architecture of the processor 3130 of FIG. 31A, in accordance with various embodiments.

FIG. 32 depicts an example network 3200 including one or more of the camera units of FIG. 31A, in accordance with various embodiments.

FIG. 33 depicts an example side view of a camera unit 3300 including a spring-biased cover 3305, in accordance with various embodiments.

FIG. 34 depicts an example of multiple overlays 3410 and 3420 for a camera lens 3400, in accordance with various embodiments.

FIG. 35 depicts an example UI 3500 that includes a region 3510 with a full-quality version of a video of a bedroom and a region 3520 with a reduced-quality version of the video of a kitchen, in accordance with various embodiments.

FIG. 36 depicts an example UI 3600 for setting events and rules, in accordance with various embodiments.

FIG. 37 depicts an example UI pop up message 3700 that indicates a user has changed the privacy mode of a kitchen camera, in accordance with various embodiments.

FIG. 38 depicts an example UI 3800 including a reduced-quality version of a video 3810 from a camera in a medium privacy mode, consistent with the pop up message of FIG. 37, in accordance with various embodiments.

FIG. 39 depicts an example UI 3900 including an image 3910 of a camera location, in accordance with various embodiments.

FIG. 40 depicts an example UI 4000 indicating a number of users that have access to a camera, in accordance with various embodiments.

FIG. 41 depicts an example UI 4100 identifying users that have access to a camera, and their respective levels of access, in accordance with various embodiments.

FIG. 42 depicts an example UI 4200 for inviting a guest to have access to a camera, in accordance with various embodiments.

FIG. 43 depicts an example UI 4300 for selecting a permission level for a guest, in accordance with various embodiments.

FIG. 44 depicts an example UI 4400 of a guest that has been granted access to a camera, consistent with FIG. 43, in accordance with various embodiments.

FIG. 45 depicts an example UI 4500 in which portions 4510 and 4520 of a field of view of a camera are identified for increased privacy, in accordance with various embodiments.

FIG. 46 depicts an example UI 4600 in which portions of the field of view of FIG. 45 are displayed with a reduced quality, consistent with FIG. 45, in accordance with various embodiments.

FIG. 47 depicts a UI 4700 in a first step of an unmasking use case, in accordance with various embodiments.

FIG. 48 depicts a UI 4800 in a second step of an unmasking use case, in accordance with various embodiments.

FIG. 49 depicts a UI 4900 in a third step of an unmasking use case, in accordance with various embodiments.

FIG. 50 depicts a UI 5000 in a fourth step of an unmasking use case, in accordance with various embodiments.

FIG. 51 depicts a flowchart of an example process involving a backend user, in accordance with various embodiments.

FIG. 52 depicts a flowchart of an example process involving an adjacent user, in accordance with various embodiments.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

Digital sensing systems or devices—including, but not limited to, cameras, microphones, location-tracking components, and other sensors—are capable of collecting, processing, and transmitting data relating to environments in which they are deployed. Such systems may affect the privacy of individuals located within sensing range, whether or not those individuals are the intended users of the system. By way of example, smart home security cameras may be used to monitor spaces that are occupied by guests, neighbors, domestic workers, family members, roommates, or passersby, either intentionally or as an incidental consequence of normal operation.

Individuals who are present within the sensing environment but do not own, configure, or directly operate the sensing system (referred to herein as “adjacent users” or “non-primary users”) typically lack access to device interfaces, configuration controls, feedback mechanisms, implicit and explicit consent mechanisms, or usage benefits available to primary users. Existing privacy features and safeguards of digital sensing systems are predominantly designed for primary users, rather than for adjacent users. As a result, adjacent users have limited awareness of sensing activity, limited ability to understand system state, and limited means to influence or verify how data relating to them is collected or processed.

In some situations, primary users themselves may experience similar limitations. For example, a primary user operating or wearing a sensing device, such as a wearable audio-recording system, may be unaware that the device is actively recording or processing data a given time. In such cases, the primary user may likewise benefit from system features that provide clear indication, feedback, or reminders regarding the operational state of the sensing system, including during sensitive or context-dependent interactions.

The solutions described herein address the above and other issues.

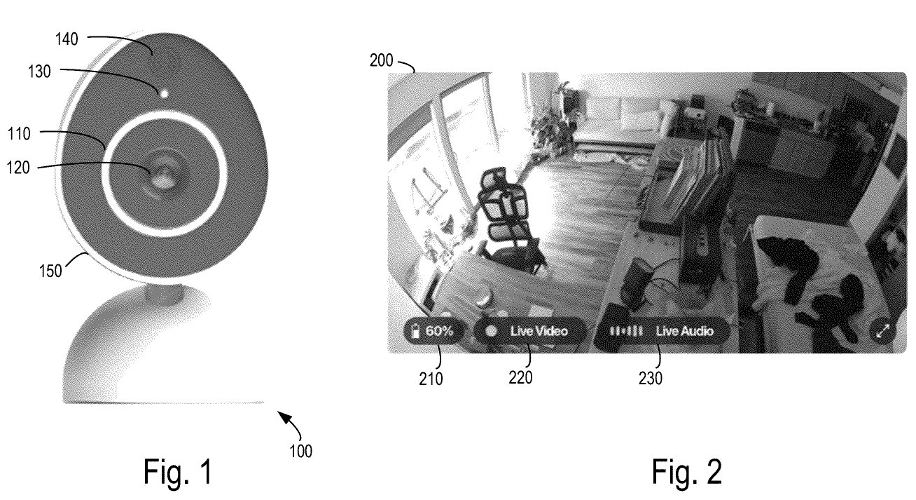

FIG. 1 depicts an example implementation of a camera unit 100 (e.g., smart camera) in a True On state, in accordance with various embodiments. The camera lens has no cover in the True On state. The camera unit include a camera lens 120, a microphone 140, a point light 130 and a privacy indicator 110. The point light can indicate a level of privacy associated with the microphone and/or the camera. The privacy indicator indicates a level of privacy associated with the camera. In one approach, the point light has a different color for each privacy level. The privacy indicator is user-perceptible which means it can be readily detected using the user's senses of vision or hearing, for instance.

The point light and the privacy indicator can be formed of light-emitting elements, such as light-emitting diodes (LEDs) that can be controlled to turn on or off and to illuminate with different colors. The privacy indicator represents a minimum level of privacy regarding the camera in this example since it is turned on and extends in a ring or full circle. The point light also represents a minimum level of privacy regarding the microphone in this example since it is turned on.

In one approach, the point light can be considered to be a separate privacy indicator for the microphone/audio. In another approach, the privacy indicator 110 represents a privacy level or state for both the camera (video/still images) and the microphone (audio). In another approach, the privacy indicator 110 represents a privacy level or state for the camera, consistent with the privacy indicator.

The privacy indicator is on the face 150 of the camera unit so that it is easily visible to people in the field of view of the camera. In another implementation, the privacy indicator can extend from the top or sides of the camera unit. In another implementation, the privacy indicator is separate from the camera unit and can communicate with the camera unit via a wired or wireless path. For example, the privacy indicator can be implemented as part of an existing lighting fixture in a room such as a lamp or overhead light.

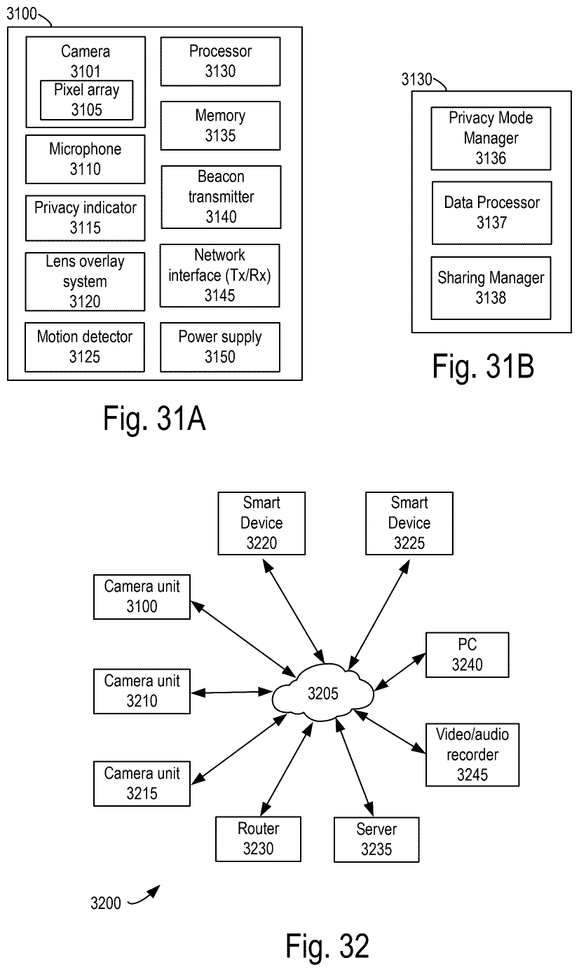

The camera unit in this example is self-contained and may include resources for power, processing, storage and communications. See FIG. 31A for an example architecture. In other implementations, one or more of the resources are provided separately from the camera unit and accessed by the camera unit via wired or wireless paths. Moreover, the camera unit may communicate with other camera units in a set via a network. See FIG. 32 for an example network.

The camera unit may be considered to be one example of a sensing system. A sensing system may collect, derive, or infer data about a physical, digital, or computational context through one or more sensing components, including but not limited to cameras, microphones, motion detectors, software-based sensors, system instrumentation, input monitoring mechanisms, keystroke monitors, AI-based observation processes, or other data acquisition techniques.

The privacy level or state may refer to a configuration of a sensing system that defines a specific set of active capabilities and restrictions. A privacy state may be characterized by the degree of capability reduction applied to the sensing device. In some aspects, privacy states may be conceptualized as existing along a spectrum between a floor or maximum privacy level with minimal or no active capabilities, and a ceiling or minimum privacy level with full capabilities enabled.

As used herein, “privacy state,”, “capability state,” and “relative reduction in capability (RRC) state,” may be used interchangeably where the context refers to enforced limitations on sensing or data processing capabilities.

The sensing system may include at least one intermediate privacy level that is between the minimum and maximum privacy levels. The at least one intermediate privacy level may activate a subset of the sensing system's full capabilities, providing a balance between functionality and privacy protection. These intermediate states may allow for granular control over sensing, processing, data transformation, storage or memory, and communication functions, such that each function may be active, inactive, or operate in a limited capacity, based on rules, policies, contextual conditions, or automated decision-making, and optionally subject to temporal, persistence, or transmission constraints.” Generally, the sensing system may include a plurality of privacy states including a first privacy state, a second privacy state, and at least one intermediate privacy state between the first and second privacy states.

In one approach, the intermediate states include a medium-low privacy level and a medium-high privacy level.

Privacy states may provide benefits across many areas, including but not limited to safety, compliance, and convenience. For example, a privacy level that limits AI and computer vision capabilities can enable users to know that a system is conforming to legal requirements or that unsafe or inconvenient features are deactivated, such as smart home automations.

In some embodiments, a privacy state is implemented not solely through on-device capability reduction, but through a data governance architecture in which one or more sensing, storage, or access capabilities are mediated by an intermediary system operating under predefined governance rules.

In such embodiments, sensor data—such as audio or video recordings—may be captured by a sensing device and transmitted to, or stored within, a trusted intermediary service configured to securely hold the data and to enforce access controls independent of the primary user. The intermediary service may be operated by a third party and may include one or more processors, secure storage, access-control logic, and audit mechanisms.

The privacy state in this architecture is defined by enforceable rules governing who may access the data, under what conditions, for what purposes, and through what procedures. Access may be permitted only upon satisfaction of specified criteria, such as receipt of a valid legal request, subpoena, court order, regulatory inquiry, workplace complaint, safety investigation, or other authorized escalation process.

While such a privacy state may allow the continued collection or retention of data, the system enforces a relative reduction in capability by preventing discretionary access, routine playback, or real-time monitoring by the primary user or other parties. In this manner, the effective capability of the sensing system is limited despite the existence of recorded data.

Indicators associated with such privacy states may communicate that data is being governed or escrowed under restricted-access conditions, rather than freely accessible or locally controlled. The indicators remain bound to the enforced governance rules such that the indicator cannot represent unrestricted access unless the corresponding governance constraints are lifted.

This approach enables privacy states that support accountability, compliance, and post hoc review—such as in caregiving facilities, workplaces, institutional environments or publicly operated or regulated sensing systems (for example, transportation or roadway monitoring systems)—while maintaining correspondence integrity between the represented state, the enforced access limitations, and the underlying technical architecture. FIG. 2 depicts an example user interface (UI) display 200 consistent with FIG. 1, in accordance with various embodiments. The display includes live video accompanied by live audio from the camera unit. The UI can be provided on a computing device of a user such as a smart phone, tablet, laptop or personal computer (PC). The UI can be provided via an application running on the device or via a web browser. The UI includes a field 210 indicating a battery level of the camera unit 100, a field 220 indicating that live video is represented and a field 230 indicating that live audio is represented.

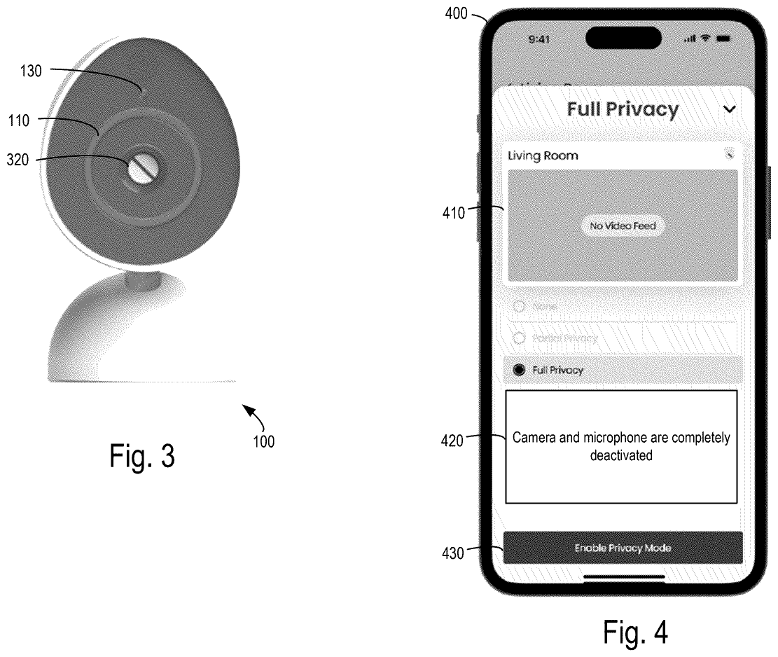

FIG. 3 depicts an example implementation of the camera unit 100 in a True Off state, in accordance with various embodiments. This state corresponds to a maximum privacy level. An electromechanically-controlled lens cover 320 is moved in front of the camera lens (from the perspective of light entering the camera) so that images cannot be captured. The lens cover has a design in the form of a slanted line that indicates to people in the field of view of the camera that the camera is off. Also, the microphone 140 is turned off as indicated by the point light 130 being off.

Note that multiple implementations are possible and do not require a physical cover or light indicator. Also note that an active “Off” light may be included to indicate a True Off state, such as a red light or an illuminated text sign that reads “True Off.”

FIG. 4 depicts an example UI 400 consistent with FIG. 3, in accordance with various embodiments. The UI notes that a full (maximum) privacy level is implemented. A region 410 indicates no video feed is available for the living room, where the camera unit is located. A region 420 informs the user that the camera and microphone are completely deactivated.

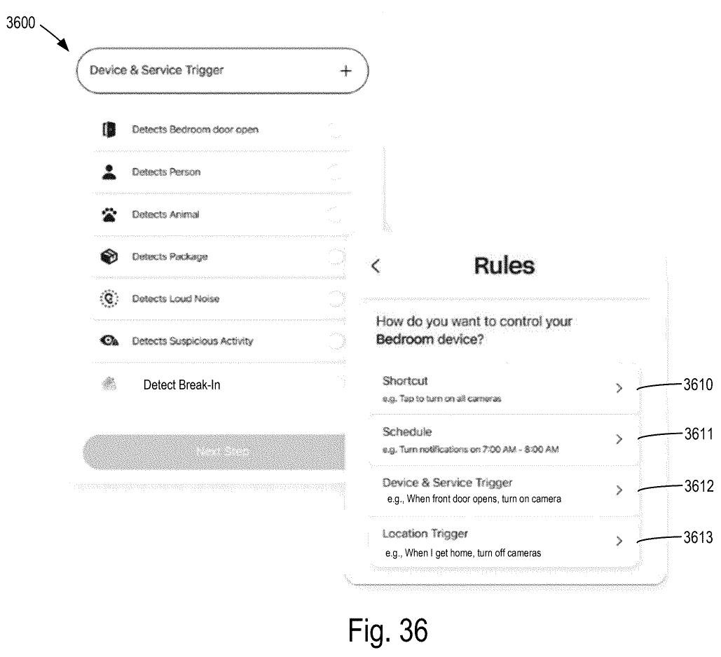

Events can include, e.g., detecting a door opening or closing, a person, a pet or other animal, arrival of a package, a loud noise, suspicious activity or a break in. See also FIG. 36.

Unlike partial (intermediate) privacy levels, recordings cannot be unmasked because no video/audio is recorded for subsequent retrieval.

A button 430 can be selected by the user to activate or enable a privacy mode of the system. In some embodiments, the button may correspond to a physical control, a graphical user interface element, or another user-actuated input mechanism. In some embodiments, activation or deactivation of the privacy mode may occur automatically in accordance with one or more predefined rules or policies, such as rules triggered by detection of specified events, conditions, schedules, or system states. In addition, the operability of a user-actuated input mechanisms—such as a physical switch located on the device—may be selectively enabled, disabled, or overridden by the system in accordance with such rules, policies, or remote control instructions, such that user actuation of the button does not result in a change to the privacy mode while the operability is disabled.

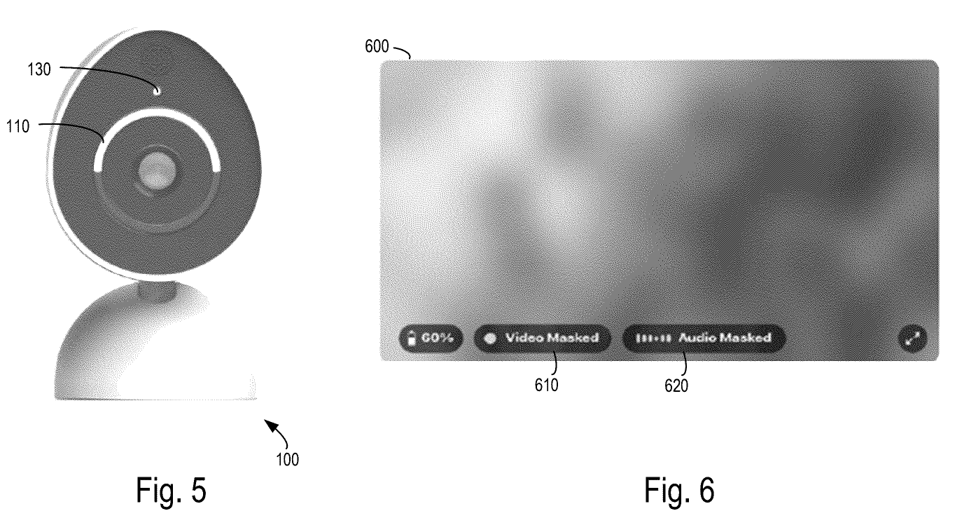

FIG. 5 depicts an example implementation of the camera unit 100 in a medium privacy level, in accordance with various embodiments. The privacy indicator 110 extends in a half ring, over 180 degrees, indicating an intermediate privacy level such as a medium privacy level. In one approach, an increasing arc length of the privacy indicator represents a decreasing privacy level. The microphone 140 is turned on as indicated by the point light 130 being on.

The privacy indicator may be orange tinted and/or have a semi-transparent or textured overlay, in an example implementation.

FIG. 6 depicts an example UI 600 consistent with FIG. 5, in accordance with various embodiment. The UI includes a field 610 indicating that masked video is represented and a field 620 indicating that masked audio is represented. Masked video refers to video that has a reduced quality compared to the full-quality video of the minimum privacy level. Masked video may be produced in various ways. In some embodiments, a light-filtering overlay may be positioned over, or in front of, the camera lens. The light-filtering overlay can provide a tint, frost, blur, diffusion or other quality-reducing effect. In one approach, the overlay is moved in place using an electromechanical actuator. In another approach, the overlay includes a material having an electrically-controllable transmissivity such as an electrophoretic or electrochromic material that remains in place over the lens.

An electrophoretic film can be built on a transparent substrate to provide an Electrophoretic Light Modulator (ELM) or e-ink glass. This is a type of smart glass that changes from transparent to opaque (frosted) or tinted by moving charged ink particles within a fluid using an electric field. The electrophoretic film may be fixed in place in front of the camera lens and activated based on the privacy level.

An electrochromic glass includes layers with electrochromic materials such as metal oxides that react to electricity, causing them to darken or clear up. For example, electrochromic materials such as tungsten oxide can be provided between glass layers. The materials change color or tint when a low voltage is applied, controlling light transmission. Applying a current moves ions, causing the material to absorb or reflect light (tinting it), while reversing the current moves the ions back, clearing the glass. It uses minimal power, only to switch states, and not to hold a state.

In addition to, or as an alternative to, physical modification of incident light, masked video be generated through one or more software-based processing techniques. For example, one or more processors may apply digital filters, transformations, or modifications to captured video data, such as blurring, pixelation, resolution reduction, region-based masking, event-based masking, noise injection, frame rate reduction, color space modification, or other algorithmic alterations that reduce or alter the informational content of the video prior to display, storage, or transmission. For example, blur effects include a Gaussian blur which is a mathematical smoothing technique often used on adjustment layers. A frosted effect can involve a layered visual technique that combines blurring with texture. It can be achieved by placing a semi-transparent shape or adjustment layer over a video, applying a heavy Gaussian blur, and adding a small amount of noise or grain to simulate glass texture. Tint and color grading can involve manipulating the video color. For example, a primary color correction can involve adjusting settings like brightness, contrast, and white balance across the entire frame. Tinting can involve applying specific color tones.

In some embodiments, physical and software-based masking techniques may be used in combination.

Note that while video is discussed above, the camera unit can capture periodic still images to which the same privacy levels can be applied.

Masked audio can be obtained in various ways such as by moving a sound-attenuation filter in front of the microphone or by processing the full-quality audio to reduce its quality using audio processing techniques. For example, frequency filtering can involve using low-pass, high-pass, or band-pass filters to remove frequency ranges where human voice characteristics reside, altering the voice's natural pitch. Pitch shifting can raise or lower the pitch of the voice to make speaker identification harder. Noise can be added by introducing white noise, pink noise, or environmental sounds (background chatter) to mask the original signal. In another approach, voice cloaking tools add subtle audio perturbations. In another approach, data compression involves reducing the sampling rate/bit depth.

Masking can also be applied in various ways to communication or location signals, including by physically attenuating or blocking electromagnetic signals associated with positioning, networking, or wireless communication functions of the device. In some embodiments, such masking is achieved through the use of electromagnetic shield structures, such as partial or complete Faraday cages, positioned around one or more components of the sensing system.

Masked sensing signals may additionally or alternatively be obtained through active signal interference techniques that introduce interfering energy into a sensing domain so as to degrade, disrupt, or limit the effectiveness of sensing, recording, or signal interpretation. In contrast to passive attenuation or shielding, active interference involves the deliberate emission of signals that interact with one or more sensors of the device or with sensors in the surrounding environment. For audio sensor masking, active interference may include the emission of sound or acoustic energy to interfere with audio capture by microphone. In the optical domain, active interference may include the emission of light intended to interfere with image capture by a camera or imaging sensor.

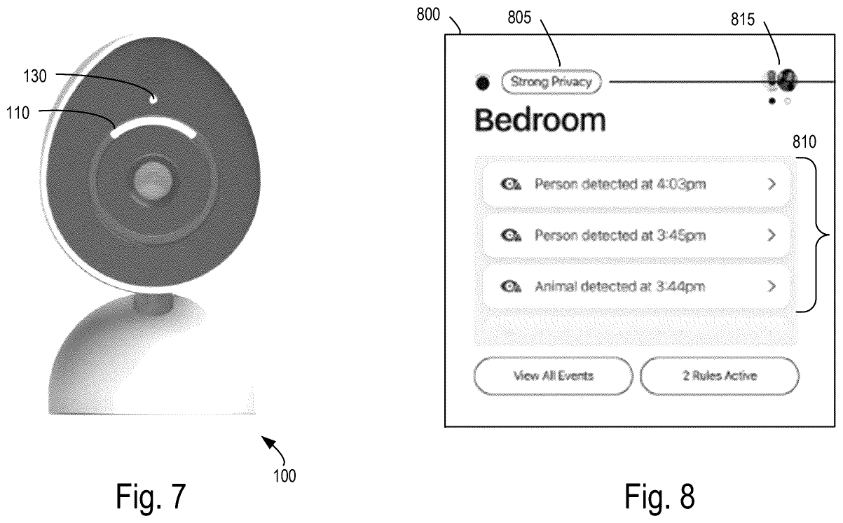

FIG. 7 depicts an example implementation of the camera unit 100 in a strong privacy state, in accordance with various embodiments. The privacy indicator 110 extends in about a quarter ring, over about 90 degrees, indicating a strong privacy level. The microphone is turned on as indicated by the point light 130 being on. With this privacy level, video is not stored but audio is stored. However, the video and audio can be processed to detect events, such as depicted in FIG. 8.

The privacy indicator may be white frosted and/or have a textured overlay, in an example implementation.

In a Strong Privacy mode, one or more sensing modalities, such as a camera and a microphone, may be fully disabled with respect to the generation, storage, or transmission of raw or processed audio and video recordings. In some embodiments, operation of the sensing system in the Strong Privacy mode restricts external data outputs to a constrained subset of information, such as textural or symbolic representations, while preventing audio or video media from leaving the device or being available for viewing or playback. In such embodiments, the system may continue to perform limited processing (e.g., local processing or edge processing) to detect events or conditions of interest and generate corresponding textual captions, summaries, or notifications. For example, the system may provide text-based notifications indicating that occupants have arrived, that a pet has entered a restricted areas, or that another predefined event has occurred, without exposing associated audio or video recordings. See FIG. 8. Other examples include dynamic masking of faces, bodies, text, or other objects/events with real-time or near-real-time AI/ML data analytics.

The on-device privacy indicators of FIGS. 1, 3, 5 and 7 can include separate camera and microphone sensor privacy indicators. Additionally, a high and low visibility option can maintain a correspondence integrity between states and indicators. For example, the camera cannot be in Full On mode unless a green light is turned on, assuming no malfunctions.

FIG. 8 depicts an example UI 800 consistent with FIG. 7, in accordance with various embodiment. A message 805 indicates the strong privacy level is active. A region 815 identifies users associated with the camera. The UI denotes events 810 that have been detected such as the presence of a person or animal. The detection can involve any person or animal or a specific person or animal. To detect any person or animal, the video can be processed to detect movement.

For example, video processing can detect the presence of a person or animal by analyzing sequential image data using a combination of classical computer vision techniques and modern machine learning models. This can involve object detection, motion analysis, and tracking algorithms.

The process can begin with capturing video frames from the camera. The frames can be preprocessed to enhance quality and prepare them for analysis. This may include resizing, noise reduction, and adjusting brightness/contrast. Relevant information (features) is then extracted from the images. This can involve methods like identifying edges, corners, or specific textures and shapes associated with the human or animal form. Machine learning models can also be used to automatically learn and extract complex features.

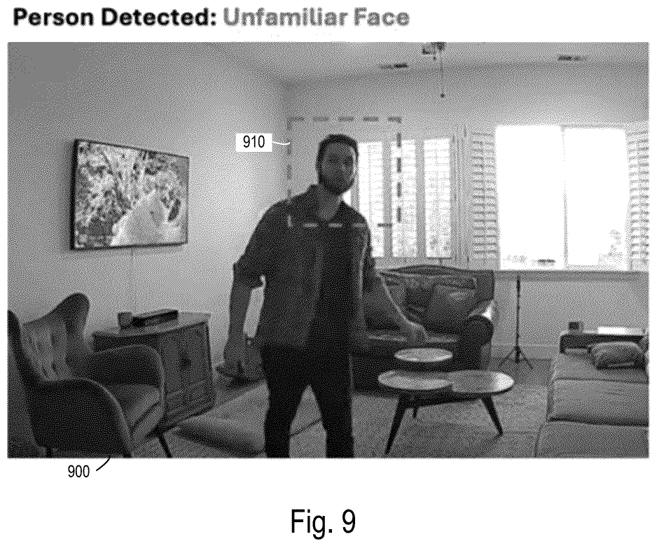

Detection algorithms include classical techniques and machine learning or AI models. Classical techniques such as background subtraction (identifying moving objects by comparing the current frame to a reference background image) and frame differencing (comparing consecutive frames to find areas of change) can locate moving objects such as people or animals. Machine learning or AI models can use convolutional neural networks (CNNs) that are trained on large datasets of images containing people or animals. They analyze the image pixels to identify patterns indicative of a human or animal and draw a bounding box around the detected person or animal. See also FIG. 9.

Once a person or animal is detected in one frame, tracking algorithms such as Kalman filters or deep learning-based trackers can be used to follow their movement across subsequent frames, ensuring consistent identification and reducing processing time. Finally, in a post-processing/confirmation process, the system interprets the results. If the detection confidence score from the AI model is high enough, the system confirms the presence of a person and can trigger actions such as recording an event, sounding an alarm, or sending a notification.

Video processing can also detect the presence of a particular person or animal. One approach involves face detection in which AI algorithms scan each frame to locate all faces present in the scene. AI algorithms such as Viola-Jones or deep learning methods like Multi-task Cascaded Convolutional Networks (MTCNN) can be used. The output is a set of bounding boxes around each detected face. Once a face is detected, the system extracts unique biometric features of the face. This can involve measuring and analyzing characteristics like the distance between the eyes, the shape of the jawline, and the contours of the facial structure. Deep neural networks such as CNNs can be used. The extracted face embeddings are compared against a pre-existing database of known individuals' (or animals') face templates. Similarity metrics, such as Euclidean distance or cosine similarity, are calculated to determine the likelihood of a match. If the similarity score is above a threshold, the system identifies the person or animal as the particular person or animal.

Other approaches can involve detecting a specific person or animal based on their walking style and movements, e.g., gait, based on machine learning models analyzing visual data to extract unique kinematic features.

FIG. 9 depicts an example image 900 from a camera in which a face is detected in a region 910, as an example of an event consistent with FIG. 8, in accordance with various embodiments. The region corresponds to a bounding box that is used in an image detection process as discussed above. Even though the camera is in the strong privacy state, where video is not displayed on the UI, the video can still be analyzed to detect events and then potentially discarded.

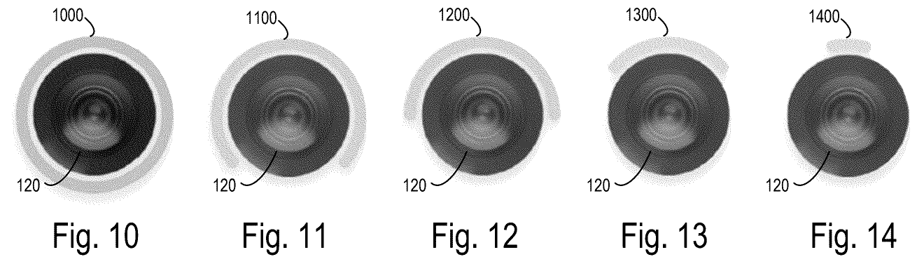

FIG. 10 depicts an example implementation of a ring-shaped privacy indicator 1000 around the camera lens 120, correspond to a minimum level of privacy, in accordance with various embodiments. This can be the True On state, for example. As mentioned, in one approach, an increasing arc length of the privacy indicator represents a decreasing privacy level. Accordingly, a full ring, extending over 360 degrees, represents the minimum privacy level, in one approach.

FIG. 11 depicts an example implementation of an arc-shaped privacy indicator 1100 around the camera lens 120, correspond to a medium-low level of privacy, in accordance with various embodiments. The privacy indicator extends in an arc of about 265 degrees, representing a second lowest privacy level.

FIG. 12 depicts an example implementation of an arc-shaped privacy indicator 1200 around the camera lens 120, correspond to a medium level of privacy, in accordance with various embodiments. The privacy indicator extends in an arc of about 180 degrees, representing a third lowest privacy level.

FIG. 13 depicts an example implementation of an arc-shaped privacy indicator 1300 around the camera lens 120, correspond to a strong level of privacy, in accordance with various embodiments. This is a medium-high level of privacy. The privacy indicator extends in an arc of about 105 degrees, representing a fourth lowest privacy level.

FIG. 14 depicts an example implementation of an arc-shaped privacy indicator 1400 around the camera lens 120, correspond to a high level of privacy, in accordance with various embodiments. The privacy indicator extends in an arc of about 35 degrees, representing a fifth lowest privacy level.

FIG. 15 depicts an example implementation of a bar-shaped privacy indicator 1500 correspond to a minimum level of privacy, in accordance with various embodiments. The bar-shaped privacy indicator can be provided as part of the camera unit such as on the front face, or at another location on or off the camera unit. The bar-shaped privacy indicator is at the longest length, indicating the minimum privacy level. In this approach, an increasing bar length of the privacy indicator represents a decreasing privacy level.

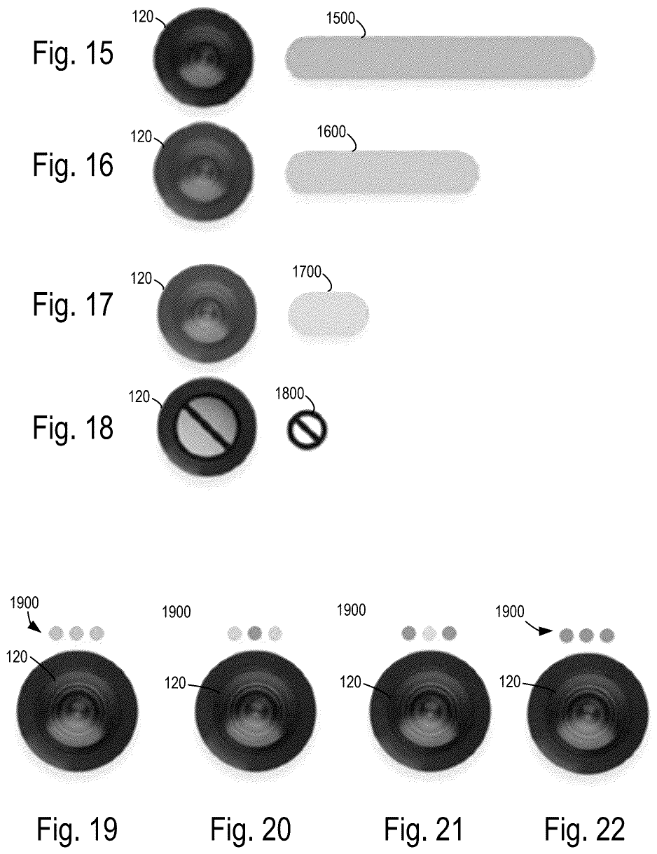

FIG. 16 depicts an example implementation of a bar-shaped privacy indicator 1600 correspond to a medium level of privacy, in accordance with various embodiments. The bar-shaped privacy indicator has a medium length, indicating a medium privacy level.

FIG. 17 depicts an example implementation of a bar-shaped privacy indicator 1700 correspond to a strong level of privacy, in accordance with various embodiments. The bar-shaped privacy indicator has a short length, indicating a strong or high privacy level.

FIG. 18 depicts an example implementation of a lens cover as a privacy indicator 1800 correspond to a maximum level of privacy, in accordance with various embodiments. The camera is covered indicating a maximum privacy level, in an example implementation.

FIG. 19 depicts an example implementation of three point lights 1900 as a privacy indicator, where the lights are all yellow (shown by a lighter shade of grey), corresponding to a minimum level of privacy, in accordance with various embodiments. The use of one or more point lights such as LEDs provides a low-cost implementation of a privacy indicator. When multiple point lights are used, the number and positions of the lights that are turned on can denote the privacy level. The colors of the lights can also denote the privacy level. The point light may be on the face of the camera unit, other location on the camera unit, or separate from the camera unit.

FIG. 20 depicts an example implementation of three point lights 1900 as a privacy indicator, where the edge lights are yellow and the middle light is red (shown by a darker shade of grey), corresponding to a medium level of privacy, in accordance with various embodiments.

FIG. 21 depicts an example implementation of three point lights 1900 as a privacy indicator, where the middle light is yellow and the edge lights are red, corresponding to a strong level of privacy, in accordance with various embodiments.

FIG. 22 depicts an example implementation of three point lights 1900 as a privacy indicator, where the lights are red, corresponding to a maximum level of privacy, in accordance with various embodiments.

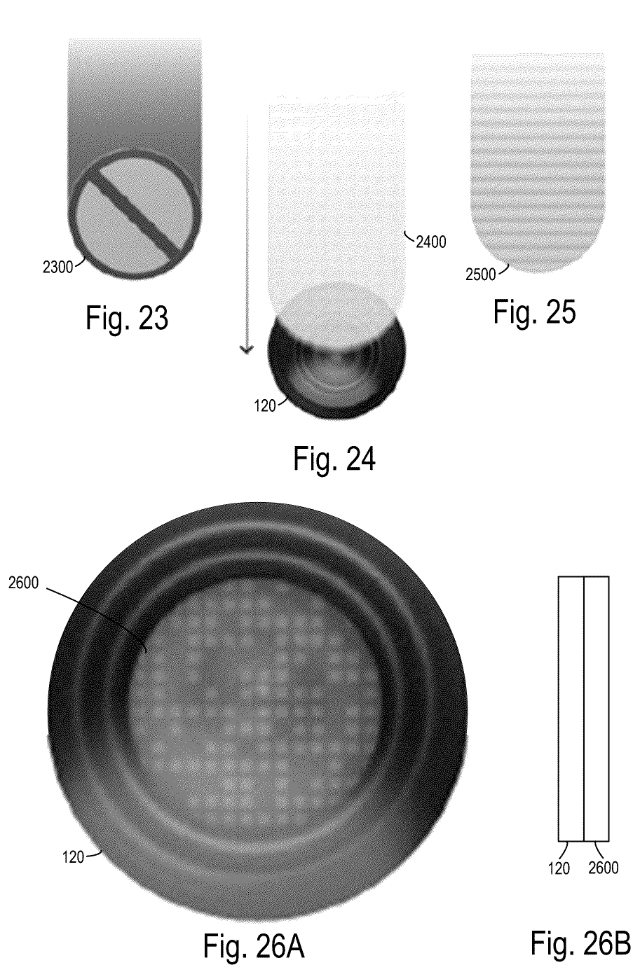

FIG. 23 depicts an example of a sensor overlay 2300 as a light-blocking lens cover, in accordance with various embodiments. As mentioned, various types of sensor overlays such as camera and microphone overlays can be used to reduce the quality of captured video or audio, respectively. FIGS. 23-26B provide examples of camera overlays. The overlays can be automatically positioned in front of (or behind) a camera lens. The overlay 2300 is a light-blocking lens that blocks all light and therefore prevents the camera from capturing images. The overlay can be positioned using an electromechanical system such as a actuator that is actuated to move the overlay in place based on a linear or rotational movement of the overlay.

FIG. 24 depicts an example of a sensor overlay 2400 as a light filter, in accordance with various embodiments. The light filter can be moved in place over the camera lens 120 to reduce the quality of the captured video. As mentioned, a light-filtering overlay can provide a tint, frost, blur or other quality-reducing change. The light filter in this example includes a grid of darkened spots to provide a diffusion filter.

FIG. 25 depicts another example of a sensor overlay 2500 as a light filter, in accordance with various embodiments. The light filter includes periodic darkened horizontal lines. Many other quality-reducing filters can be used. The quality of a video or other image can be based on factors such as sharpness, noise, dynamic range, color accuracy, and artifacts.

FIG. 26A depicts a front view of an electrophoretic overlay 2600 for the camera lens 120, in accordance with various embodiments. The electrophoretic (e-ink) overlay can be a film that is attached to the camera lens that may be glass, in one possible approach. In another approach, the e-ink overlay is on a separate glass or other transparent substrate, adjacent to or spaced apart from the camera lens. When the privacy level is a minimum, the electrophoretic overlay is clear so that the quality of the captured video is not reduced. However, for some privacy levels, an electrical charge can be applied to change the level of opacity from clear to tinted to opaque.

The electrophoretic film may use liquid crystal technology or suspended particles. When voltage is applied, tiny crystals or particles align, allowing light to pass through and make the film appear transparent or clear. A circuit can control the amount of electrical current, which determines the degree of alignment of the particles and thus the specific level of tinting. This provides variable, on-demand control over light transmission and privacy. The transition between clear and an opaque or tinted state is typically quick, often happening in less than one second for some types of film. A burst of electricity is used to change the state, but little to no additional electricity is required to maintain the selected shade, to avoid excessive power consumption.

In an example implementation, the electrophoretic overlay is controlled to provide a pattern, such as a diagonal bar, similar to FIG. 23, which informs the user of the privacy state.

The e-ink overlay creates many opportunities for more advanced applications of sensor overlay/privacy indicators. For example, aesthetically intriguing privacy masks applied to video can be represented with e-ink lens covers.

FIG. 26B depicts a side view of the electrophoretic overlay 2600 and the camera lens 120 of FIG. 26A, in accordance with various embodiments. The overlay is placed adjacent to the lens 120 in this example.

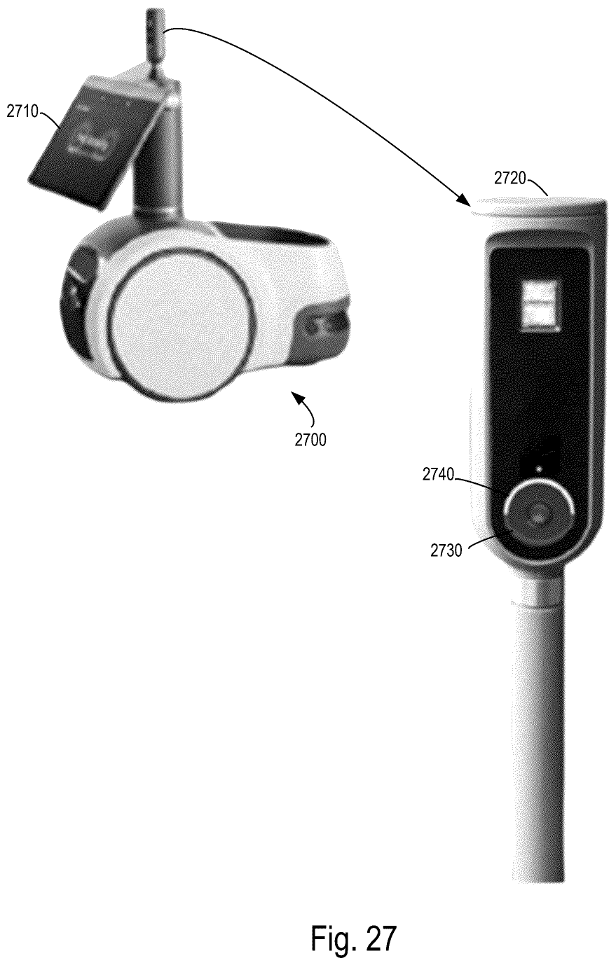

FIG. 27 depicts an example of a robot 2700 having a privacy indicator 2740, in accordance with various embodiments. A camera unit with a privacy indicator can be provided in a number of different configurations. In this configuration, a domestic robot includes a screen 2710 and a camera tower 2720. The camera tower includes a camera 2730 and a privacy indicator 2740 similar to the privacy indicator 110 of FIG. 1.

This is an example of an autonomously mobile smart camera. These robot devices can create significant adjacent actor privacy concerns. However these devices are new, expensive, and it is unclear whether they will become as common as standalone smart home cameras.

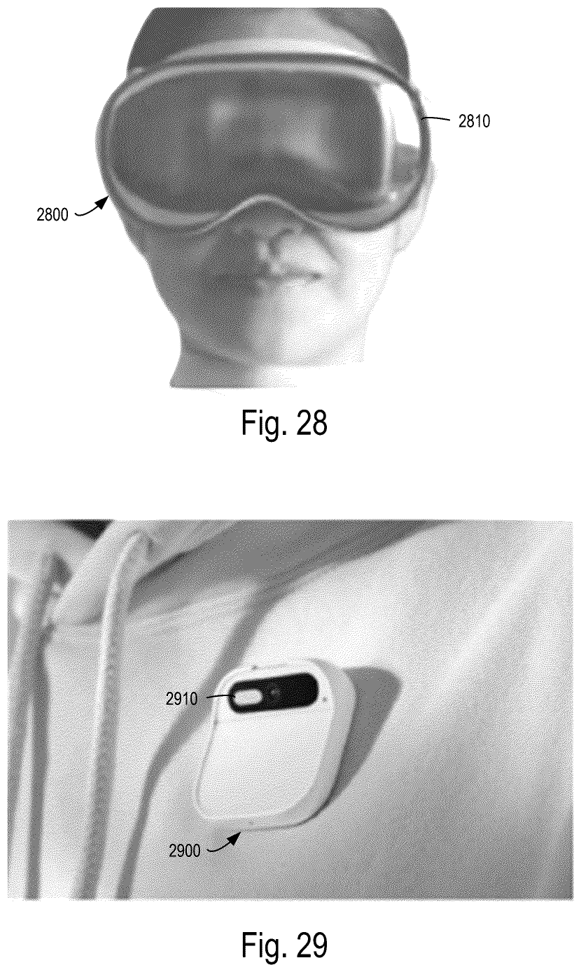

FIG. 28 depicts an example of smart glasses 2800 having a privacy indicator 2810, in accordance with various embodiments. The smart glasses are an example of a mixed reality and spatial computing product. The privacy indicator 2810 extends along a side of the smart glasses. The illuminated portion of the privacy indicator can be adjusted, so that the vertical length of the illuminated portion is a function of the privacy level. The privacy indicator can be uses to communicate the privacy state of the smart glasses to other users. In one embodiment, the bar shaped or point light implementation may be positioned on a front-facing portion of the glasses, on an arm of the glasses, or on both. In another embodiment, a user may select between a high-visibility configuration in which one or more front-facing indicators are active and a low-visibility configuration in which only indicators located on the arm of the glasses are active. The high-visibility option may be selected in contexts where enhanced notice or conspicuity of the privacy state and indicator is desirable, such as workplace, institutional, or security-sensitive environments, whereas the low-visibility option may be selected in contexts where reduced conspicuity is preferred, such as informal or social environments. Together, the high-visibility and low-visibility configurations enable the system to maintain correspondence integrity by presenting different but consistent visual representations of the same underlying privacy state information across varying contexts and use conditions.

FIG. 29 depicts an example of a wearable device 2900 having a privacy indicator 2910, in accordance with various embodiments. The privacy indicator can increase trust with others by informing them of when they are being recorded. In this example, the illuminated portion of the privacy indicator can be adjusted, so that the horizontal length of the illuminated portion is a function of the privacy level.

FIGS. 28 and 29 provide examples of wearable smart cameras. These include smart glasses and action cameras. Action cameras are typically used in an on-and-off manner for specialized activities, often outdoor adventures. Smart glasses may involve often-on cameras used across many everyday contexts.

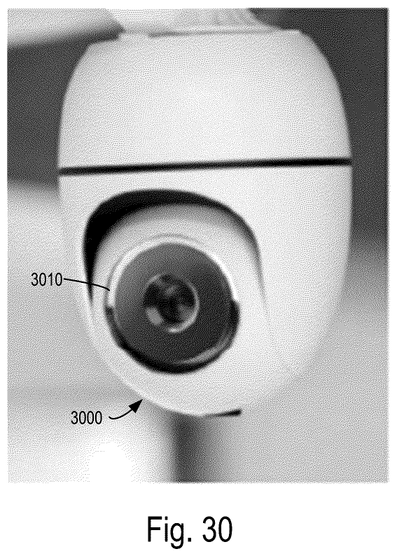

FIG. 30 depicts an example of a movable camera 3000 having a privacy indicator 3010, in accordance with various embodiments. Movable cameras are used in many contexts beyond the home, such as small business, care-giving and public spaces. The privacy indicator can provide peace of mind to workers, clients, patrons and others by informing them of the current privacy level of the camera.

FIGS. 1 and 30 provide examples of a stationary or semi-stationary standalone smart cameras. These cameras are typically used in an always-on or often-on state. Consequently, they are very likely to affect nearby actor privacy.

Other example types of smart cameras include integrated cameras on portable smart computing devices such as smart phones, tablets, laptops, televisions, Internet-of Things (IoT) devices (smart doorbells, smart locks, baby monitors), drones, exercise bikes, robots, motion detectors and industrial handheld devices such as used in warehouses for inventory management. These cameras are often mobile which can increase privacy concerns for adjacent actors. But overall, they tend to be less privacy-invasive because they are task-oriented, and cameras and microphones are disabled when not in use. These devices are also not specifically designed for surveillance. Moreover, in addition to smart cameras, the techniques herein can be applied to devices that do not have a camera or microphone. For examples, the techniques can provide information regarding privacy settings involving whether or not history logs and events are shared with the owner of the device. The techniques can also involve showing how a phantom state (e.g., standby or sleep mode) can be displayed and attested for any smart device.

Generally, many emerging smart devices will include cameras and microphones that can benefit from the use of a privacy indicator. Moreover, beyond the use of two-dimensional cameras, the solutions herein can be used for infrared and three-dimensional cameras and other spatial sensor systems such as Global Positioning System (GPS), Wi-Fi, Light Detection and Ranging (LiDAR) and (Radio Detection and Ranging (RADAR). For example, devices that operate using these systems can include privacy indicators to inform people of the current privacy level of the system.

FIG. 31A depicts an example block diagram of an architecture of a camera unit 3100, in accordance with various embodiments. The camera unit may include a pixel array 3105 such as a Complementary Metal-Oxide-Semiconductor (CMOS) array. The pixel array is part of a camera 3101 that also includes a lens. A CMOS pixel array works by converting light into electrical signals at each pixel, then reading those signals out row by row. Each pixel contains a photodiode and transistors to amplify and convert the light's charge into a voltage, which is then digitized for image processing.

Another option is a Charge-Coupled Device (CCD) pixel array. A CCD pixel array works by converting light into electrical charges within tiny silicon pixels during exposure, storing these charges in potential wells, and then clocking them row-by-row into a readout register. The readout register shifts the charges to an output amplifier to create a digital voltage signal proportional to the light intensity for each pixel, thereby forming a digital image.

A microphone 3110 can be implemented by a Micro-Electro-Mechanical Systems (MEMS) sensor element and an Application-Specific Integrated Circuit (ASIC) housed in a single package. The microphone can include an acoustic port that allows sound waves to enter the device, and a MEMS sensor (transducer) that includes a diaphragm and a backplate close to the diaphragm which together form a sound-sensitive capacitor. The movement of the diaphragm changes the capacitance between the two plates, which is converted into an electrical signal. The ASIC manages the electronics and processing tasks and may include an amplifier, a power management circuit, and an Analog-to-Digital Converter (ADC).

A privacy indicator 3115 can be any of the privacy indicators described herein. It can include visual, audible, and/or tactile components. The visual component can include a display that can be controlled to vary in terms of its size, shape, color and/or brightness. The audible component can include a speaker that can be activated to play sounds such as a beep or chime, or a recorded voice message, to indicate a current privacy level. The tactile component may include one or more haptic actuators configured to provide tactile feedback, such as vibration, pulsing, patterned haptic signals, or static state changes, to convey the current privacy level or changes of state.

A lens overlay system 3120 can include a mechanical lens cover or other overlay that is moved in place by an electromechanical actuator, for instance, such as depicted in connection with FIGS. 23-25, 33 and 34. The lens overlay system 3120 can also include electrophoretic or electrochromic overlay and associated control circuits.

A motion detector 3125 can be provided to detect movement of people or animals. For example, it may include a passive infrared detector. In some cases, the detected motion can be used to wake up the camera unit from a sleep state in which it does not record audio and/or video, to a wake state in which it records audio and/or video. The sleep state of the camera may correspond to a sleep state of the processor.

A processor 3130 may execute instructions (e.g., software and/or firmware) stored in a memory 3135 to provide the functions described herein. The processor can represent one or more processors such as Digital Signal Processors (DSPs), Field-Programmable Gate Arrays (FPGAs), Arm Central Processing Units (CPUs), and Vision Processing Units (VPUs). A VPU is a microprocessor designed to accelerate computer vision and AI tasks, such as object detection and facial recognition, by efficiently processing visual data in real-time.

The memory 3135 may be a tangible, non-transitory computer-readable storage device. The memory can include volatile memory such as random-access memory (RAM) for active tasks and non-volatile memory for long-term storage of video, audio, firmware and user settings. The memory can include a memory card for local storage, such as microSD card. The video and audio can be sent to local or remote server for long-term storage.

The memory and processor may be part of a system-on-chip, for example.

A beacon transmitter 3140 can be provided to periodically broadcast information wirelessly such as an identifier of the current privacy level of the camera unit. This information can be received by smart computing devices such as smart phones of users in the area of the camera unit. The smart phone can have an application or other software that processes the received information and displays it to the user to inform them of the current privacy level. In another approach, the beacon transmitter 3140 transmits an identifier of the camera unit and the smart device responds by querying the camera unit (via its network interface 3145) to obtain the current privacy level or other data such as information regarding the owner of the camera, the type of camera, a view of the current video of the camera, or a playback of the current audio of the camera.

A network interface 3145 may include a transmitter (Tx) and a receiver (Rx). The network interface can include a wireless interface such as a Wi-Fi interface and/or a wired interface such as an Ethernet interface. The interface can be provided as a separate module, in one possible approach. The network interface may allow a camera unit to communicate with one or more other camera units in a network of camera units, such as in different interior and/or exterior locations of a user's home. For example, a camera unit may transmit its current privacy level to one or more other camera units and they may respond by changing their privacy levels, e.g., to match the transmitted privacy level. For instance, when one camera unit detects an event such as the presence of a person in a room, it may change its privacy level and inform the other camera units. The one camera unit can transmit the change as a broadcast message that the other camera units can receive at the same time, or as separate end-to-end messages.

The network interface 3145 can also communicate with smart devices of users as mentioned such as to respond to requests for information regarding the camera unit.

A power supply 3150 can be an on-board battery of a standalone, wireless camera unit or a power converter of a wired camera unit. A wired camera unit can also include a backup battery for use in case of power loss.

In some aspects, the components of the camera unit 3100 may be interconnected to enable the flow of data and control signals throughout the system. For example, the pixel array and microphone may feed sensor data to the processor, which may then process this data according to the privacy mode settings. The privacy indicator may receive signals from the processor to display the current privacy state. The memory may store the captured data, privacy settings, and sharing configurations accessed by the processor.

FIG. 31B depicts an example block diagram of an architecture of the processor 3130 of FIG. 31A, in accordance with various embodiments. The processor manages system operations and may interface with three functional modules: a privacy mode manager 3136, a data processor 3137, and a sharing manager 3138. The privacy mode manager may control the different privacy levels of the system, including True On, True Off, and intermediate privacy levels. The data processor may handle the processing of captured sensor data according to the current privacy level settings. The sharing manager may control access to the processed data based on predefined sharing settings for different users.

FIG. 32 depicts an example network 3200 including one or more of the camera units of FIG. 31A, in accordance with various embodiments. The network includes a cloud 3205 or communication medium that can be wired and/or wireless, and can include a local area network (LAN) and/or a wide area network (WAN) such as the internet. The network can include one or more camera units, such as camera units 3100, 3210 and 3215, and one or more user devices such as smart user devices 3220 and 3225.

A personal computer (PC) 3240 or one of the smart user devices can be used to communicate with the camera units such as to receive video and audio and to provide user settings. A video/audio recorder 3245 can be used for local long-term storage of video and audio from the camera units. A router 3230 can be used to interface with a local or remote server 3235. The server 3235 can be local to a user's home or business or remote, such as with a cloud-based server. For example, the router can transmit video and audio to the server for long-term storage and/or analysis, and the server can transmit requested portions of the video and audio for playback on the user devices, and results from the analysis. These results can include identification of events, for instance. Event detection can also occur using the local processing and memory resources of a camera unit. The server can also be accessed by a user's computing device to remotely obtain video and audio and to provide user settings.

The smart user devices can be wireless computing devices that are carried or worn by users, for instance, such as smart phones, smart watches, fitness monitors, and smart glasses.

In one approach, a camera unit receives a broadcast wireless signal from a smart user device, where the wireless signal comprises an identifier associated with the smart user device. For example, a smart user device can use Bluetooth Low Energy (BLE) technology to broadcast small data packets that alert nearby cameras of their presence. One or more processors of the camera unit may be configured to execute the instructions to determine a current privacy level based on the identifier. In this approach, the detection of the presence or departure of a particular person via their smart device can be an event that triggers a change in the privacy level. The privacy level can therefore be tailored to the particular users that are present. The smart user device can be linked to a profile of a user of the camera network in a registration process.

In the case of the presence of multiple users, it is possible to assign respective priorities to the user's and their devices so that the privacy level is set based on the detected user with the highest priority level. The detection of users based on their smart devices can be more efficient and reliable compared to approaches such as facial detection from the video.

Another approach involves detecting at least first and second events in a field of view of a camera. This detection can be based on video and/or audio from the camera, and/or detection of wireless signals from user smart devices. One or more processors of the camera unit may be configured to execute the instructions to determine the current privacy level based on respective priorities of the first and second events. The events can be the detection of people or animals in general, the detection of specific people or animals, or the detection of any other event such as depicted in FIG. 36.

While the example network includes camera units, it can more generally include a network of sensing systems.

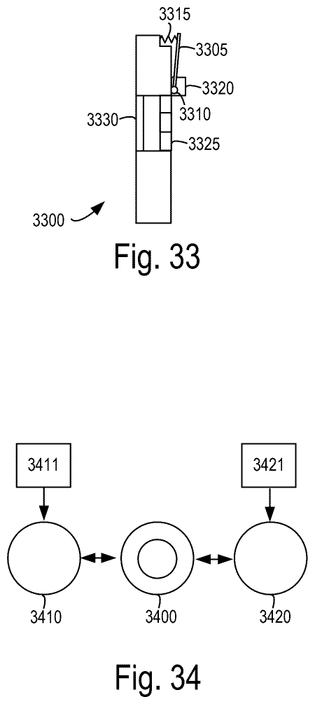

FIG. 33 depicts an example side view of a camera unit 3300 including a spring-biased cover 3305, in accordance with various embodiments. The spring-biased cover can move to the closed position in which the cover blocks the camera lens when there is a loss of power at the camera unit. This can occur, e.g., when an on-board battery is discharged or when there is a power loss on a wired power path to the camera unit, such as with a Power over Ethernet (PoE) configuration. The camera unit includes a pixel array 3330, and a lens 3325 in front of the pixel array. The spring-biased cover can rotate about an axle 3310 between an open position, as shown, and a closed position in which it is in front of and blocks the camera lens. An electromechanical actuator 3320 can be attached to the axle to move the cover to the open position. When there is a loss of power, the electromechanical actuator allows the cover to rotate freely so that the spring 3315 biases it to the closed position. The cover can have a design such as a diagonal bar that informs the user that the camera is blocked. This assures the user that the camera is not recording.

Various other implementations can be used as well for a power-off lens cover. Generally, the power-off lens cover is a No-Power True-Off Indicator. It includes a mechanically actuated indicator that visibly changes and maintains state when power is lost or disconnected. For example, the cover 3305 can be a white spring-loaded plastic piece that is unlatched if power is disconnected, creating a contrast with a dark surrounding surface of the housing of the camera unit. This provides a passive and power-independent indication of a True-Off or inactive state of the camera.

FIG. 34 depicts an example of multiple overlays 3410 and 3420 for a camera lens 3400, consistent with FIG. 43, in accordance with various embodiments. The different overlays can be associated with different privacy levels, for example. In one approach, the first and second overlays 3410 and 3420, respectively, provide first and second reductions, respectively, in video quality. For example, the overlays can provide different levels of tint, frost, blur, diffusion or other quality-reducing changes. Each of the overlays 3410 and 3420 can be controlled by a respective electromechanical actuator 3411 or 3421 to move the overlay in front of the camera lens 3400. In one approach, the overlays are used one at a time. In another approach, multiple overlays can be used together.

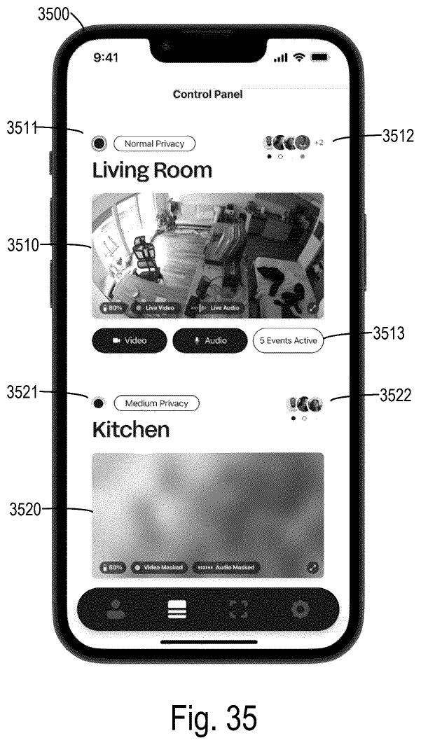

FIG. 35 depicts an example UI 3500 that includes a region 3510 with a full-quality version of a video of a bedroom and a region 3520 with a reduced-quality version of the video of a kitchen, in accordance with various embodiments. The UI may be provided by a smart phone application, for example, which allows a user to view the video feed from each camera in a home. For each camera, the UI identifies the associated room in the home and the current privacy levels. The UI can also identify one or more users that have access to the associated camera.

For example, a region 3510 depicts a live full-quality video feed of the camera in the living room. A live audio feed may be played as well. The region 3511 denotes that normal privacy is set for the camera. This can be a minimum privacy level, for example. The region 3511 also denotes the appearance of the privacy indicator, e.g., a green ring. A region 3512 denotes users that have access to the camera by providing their profile pictures. The +2 denotes two other users, for a total of six users. A region 3513 indicates that five events are active.

A region 3520 depicts a live reduced-quality version of a video feed of the camera in the kitchen. A masked audio feed may be played as well. The region 3521 denotes that medium privacy is set for the camera. The region 3521 also denotes the appearance of the privacy indicator, e.g., a yellow half ring. A region 3522 denotes three users that have access to the camera by providing their profile pictures. Thus, a different number of users can have access to different cameras in a network of cameras.

FIG. 36 depicts an example UI 3600 for setting events and rules, in accordance with various embodiments. The rules can be simple or complex rules that are created to trigger automated switching between privacy levels. A simple rule can involve a single event that triggers a change. A complex rule can involve multiple events that trigger a change.

Example events include detecting a bedroom door open, a person (any person), a specific person, an animal, a package being delivered, a loud noise, suspicious activity or a break in. Other example events could include a fire, the presence of vehicles outside the home, sounds such as a baby crying or glass breaking, and so forth.

A UI element can be provided that allows the user to select each event. The example rules ask the user how they would like to control the bedroom device (camera unit). A shortcut button 3610 can turn on all cameras in the bedroom or the network. A schedule button 3611 can turn on notifications at specific times of day. A device and service trigger button 3612 can set up an action such as turning on the cameras when the front door opens. A location trigger button 3613 can set up an action such as turning off the cameras when the user returns home.

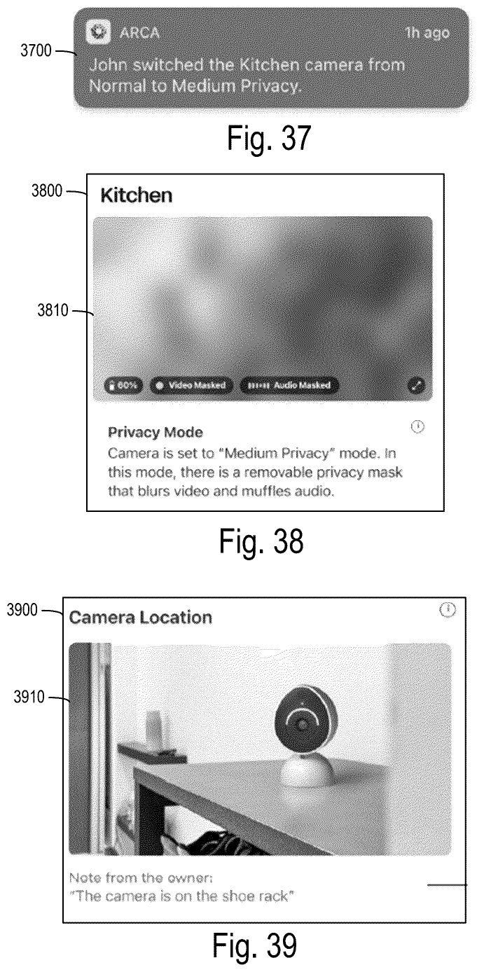

FIG. 37 depicts an example UI pop up message 3700 that indicates a user has changed the privacy mode of a kitchen camera, in accordance with various embodiments. The message states: “John switched the Kitchen camera from Normal to Medium Privacy.” This message can be provided on the UIs of each of the user who have been granted access to the kitchen camera.

FIG. 38 depicts an example UI 3800 including a reduced-quality version of a video 3810 from a camera in a medium privacy mode, consistent with the pop-up message of FIG. 37, in accordance with various embodiments. The reduced-quality is provided based on the medium privacy level. The UI also includes a message informing the user that the camera is set to the medium privacy mode. In this mode, there is a removable privacy mask that blurs the video and muffles the audio.

FIG. 39 depicts an example UI 3900 including an image 3910 of a camera location, in accordance with various embodiments. The owner of the camera can take a photo showing the location of the camera in the room, for example, and share this photo with other users who have been granted access to the camera. This helps the other users understand where the camera is located and can be helpful, e.g., when the camera is in a hidden location or when there are multiple cameras in one room. The photo can be taken with the owner's smart phone, for example, and uploaded to an application for controlling the camera. The UI includes a note from the owner stating: “The camera is on the shoe rack.”

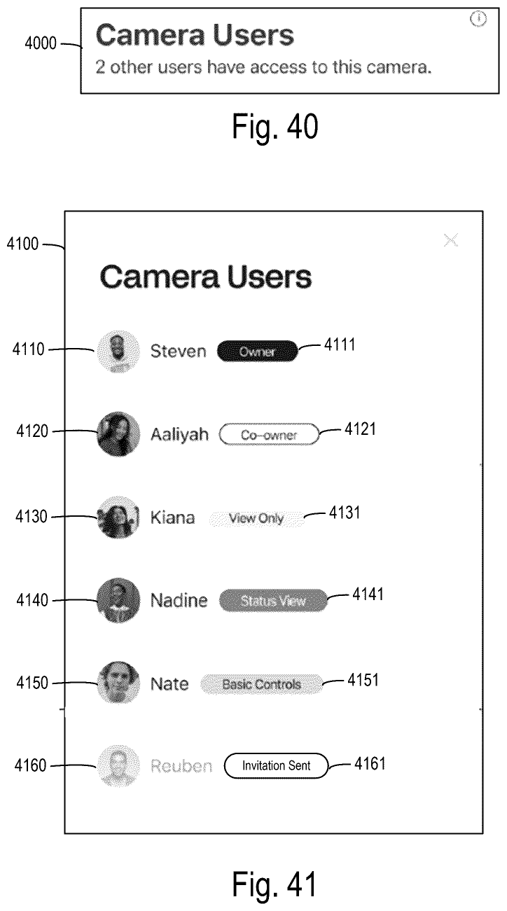

FIG. 40 depicts an example UI 4000 indicating a number of users that have access to a camera, in accordance with various embodiments. In this example, two other users have access to the camera.

FIG. 41 depicts an example UI 4100 identifying users that have access to a camera, and their respective levels of access, in accordance with various embodiments. Names and profile photos 4110, 4120, 4130, 4140, 4150 and 4160 of the users are displayed. The level of access is also displayed. The access levels can include: owner, co-owner, view only, status view, basic controls and invitation sent, as identified at regions 4111, 4121, 4131, 4141, 4151 and 4161, respectively. The owner has full control over the camera including the ability to grant and remove access for other users. The co-owner has full access to the camera, including both viewing and control permissions. With view only, the user is a guest that can view the status and live feeds of the camera, but cannot control the camera such as by changing its settings or privacy level. With status view, the user is a guest that has access to only the status, e.g., privacy level, of the camera and cannot view a live feed or control it. With basic controls, the user is a guest that can view the live feed and has basic control over the camera. With invitation sent, the user does not yet have access to the camera until the invitation is accepted.

The provision of multiple, differentiated access levels addresses limitations of conventional access-control mechanisms for both primary and adjacent users. Existing approaches, such as privacy zones or binary sharing models, typically require granting broad access in order to convey system state, functionality, capabilities, or absent capabilities. In contrast, the access levels described here enable a primary user to selectively and securely expose limited information—such as a current privacy level or operational status—to adjacent or secondary users without granting full viewing and/or control permissions. This allows privacy-related information (such as the application of a masked area that blocks a neighbor's property) to be communicated in a manner that is verifiable and proportionate the recipient's role, while preserving the primary user's preferred boundaries of access, control, and awareness.

With Status View, owners can share only basic information about the settings or location of the device. For example, owners can use Status View to show a guest where their cameras are located and demonstrate that they are set to a privacy mode.

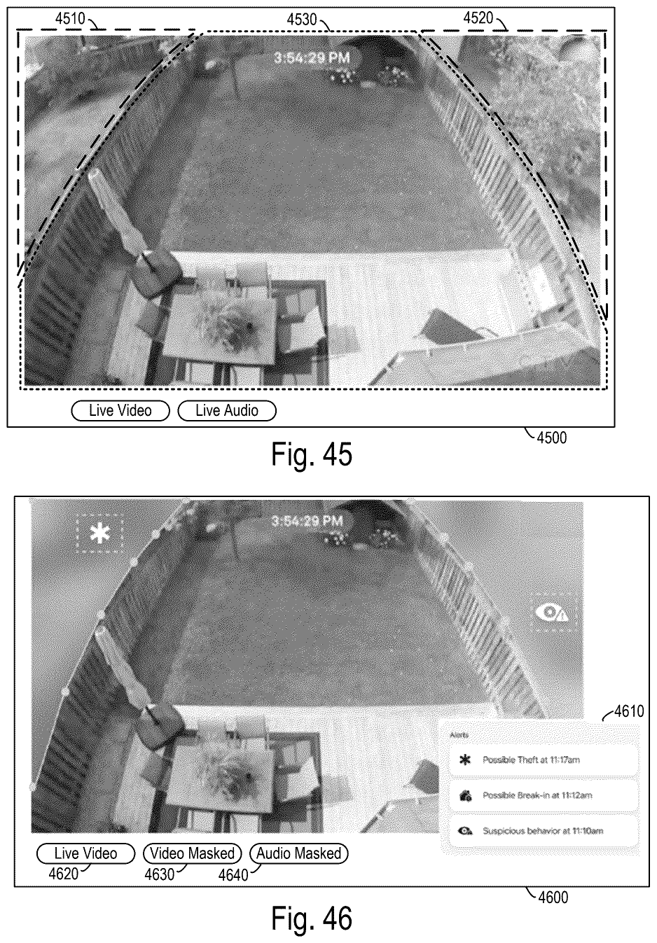

Status View is a versatile feature that allows users to customize the information they share with neighbors, guests, or tenants. For example, users can create a Neighbor View that demonstrates to a next-door neighbor that the camera is not violating their privacy. Used in conjunction with the Privacy Zone feature, users can segment a portion of the field of view to block a neighbor's property, such as depicted in FIG. 45. Status view allows the neighbor to verify it. The segmenting can involve a UI where the user uses a cursor or their finger to outline the areas to block or use.

If owners want to inform others but without sharing access, they can instead send a Shareable Mode Guide. This allows adjacent users to learn about the different modes and have greater trust that their privacy is being protected.

If owners want to give someone more access, they can select from three tiered levels. Co-Owner grants full access. Basic Controls grant access to displays and mode selection but do not allow more advanced settings like sharing access or configuring events. View Only limits access to live video/audio and recorded timeline events. If none of these are suitable, owners can create a Custom category of shared access.

The Status View capability is particularly important for balancing the security of the primary user with privacy and information-sharing desires of adjacent users. A primary user can send an adjacent user (1) an active indication status, e.g., a smartphone application interface that shows the color/state of an indicator along with (2) a text description of the indication state, and (3) potentially other information such as an authentication or trusted source (the application alone provides evidence of trust by revealing that brand/backend user) and metadata such as device owner, location, dates, service provider, upcoming changes or updates, etc.

This Status View capability would explicitly not allow other commonly shared access permissions, particularly the pass-through of any data other than the indicator status, description key, and potential metadata. No video, audio, controls, etc. may be allowed to pass through.

Status View can be considered a particular “very low ceiling” access permission.

Users other than the owner can be considered to be non-owners.

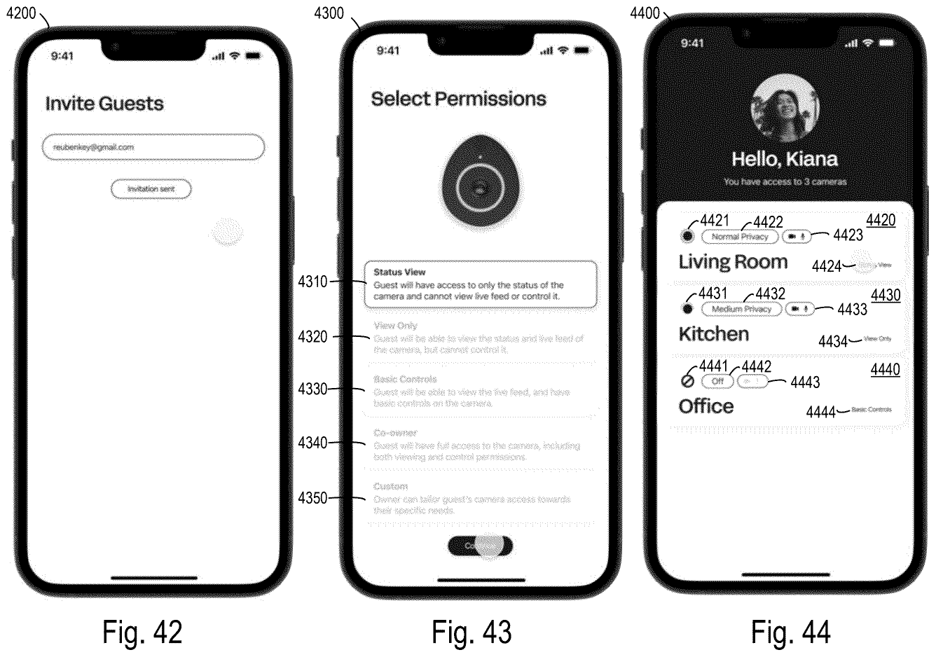

FIGS. 42-44 show example flexible share screens for inviting guests, selecting permissions, sharing with guests, and viewing status only and limited data views (e.g., notes from primary user, locations of devices/sensors, status and capabilities, but without fuller access to data or controls).

FIG. 42 depicts an example UI 4200 for inviting a guest to have access to a camera, in accordance with various embodiments. The UI has a field in which the email address of the invitee is entered.

FIG. 43 depicts an example UI 4300 for selecting a permission level for a guest, in accordance with various embodiments. The permission levels include status view, view only, basic controls, and co-owner, as discussed above, in regions 4310, 4320, 4330, and 4340, respectively. Additionally, a custom permission level in a region 4350 can allow an owner to tailor a guest's camera access based on the guest's specific needs.

FIG. 44 depicts an example UI 4400 of a guest that has been granted access to a camera, in accordance with various embodiments. The UI informs the user that they have access to three cameras and that these cameras are in a living room, a kitchen and an office.

A region 4420 describes features of the living room camera. A privacy indicator 4421 and a note 4422 denote a normal (e.g., minimum) privacy level. An icon 4423 depicts a camera and a microphone to indicate that both video and audio monitoring are active. A note 4424 informs the user that they have a “status view” permission level for this camera.

A region 4430 describes features of the kitchen camera. A privacy indicator 4431 and a note 4432 denote a medium privacy level. An icon 4433 depicts a camera and a microphone to indicate that both video and audio monitoring are active. A note 4434 informs the user that they have a “view only” permission level for this camera.

A region 4440 describes features of the office camera. A privacy indicator 4441 and a note 4442 denote a maximum privacy level. A greyed out icon 4443 depicts a camera and a microphone to indicate that both video and audio monitoring are inactive. A note 4444 informs the user that they have a “basic controls” permission level for this camera.

FIG. 45 depicts an example UI 4500 in which portions 4510 and 4520 of a field of view of a camera are identified for increased privacy, in accordance with various embodiments. A remaining portion 4530 is not identified for increased privacy. The areas of increased privacy can be identified in different ways. In one approach, the user employs a mouse or other point device with a UI to draw a bounding shape around a portion of an image. Or, a finger can be used to draw on a touchscreen. In another possible approach, the UI automatically segments the image into different areas based on boundary lines, for example, such as by detecting the fences. In this example, the portions 4510 and 4520 correspond to the backyards of neighbors on opposing sides of the owner's yard.

In one approach, the owner of the camera unit, whose backyard is not to be blurred, is the user that identifies the areas of increased privacy. In another approach, the owners grants permission for one or more of the neighbors to access a UI to identify the areas of increased privacy. Via a UI, the owner can provide a sharing setting for one or more users (neighbors). The sharing setting can include a permission for the one or more users to request a change to the current privacy level for a subset of a field of view of the smart camera. The UI then communicates the permission to a user interface of the one or more users.

In another approach, the owner provides an initial identification of the areas of increased privacy, and the neighbor modifies this identification, and requests permission to use the modified identification. The owner user can then approve the request, deny it outright, or deny it but provide a further modified identification, in a back and forth process.

FIG. 46 depicts an example UI 4600 in which portions of the field of view of FIG. 45 are displayed with a reduced quality, consistent with FIG. 45, in accordance with various embodiments. Based on the control inputs made with the UI of FIG. 45, the portions 4510 and 4520 of the field of view are blurred. This helps maintain the neighbors' privacy. The owner can further grant access to the neighbors' so that they can view the video feed and confirm that their backyards are blurred. In another option, the owner can send an image of the video feed to provide the confirmation without granting access.

The UI includes a region 4610 depicting detected events including a possible theft, a possible break-in and suspicious behavior. The UI also includes a message 4620 indicating the video feed is live. The message 4630 indicates the video is masked, e.g., in part, and the message 4640 indicates the audio is masked.

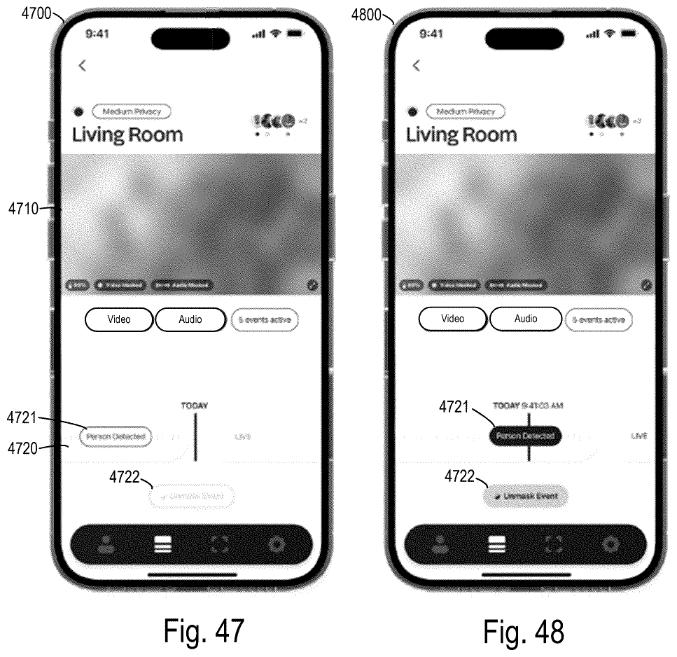

FIGS. 47-50 depict steps in an unmasking use case. Unmasking can involve restoring a reduced-quality video to full-quality, or at least to a higher quality. In one approach, both the masked version of the video and the full-quality version of the video are stored so that the unmasking can involve accessing the full-quality video in place of the masked video. In another approach, masked video can be processed to recover the full-quality video.

Also, both the masked version of the audio and the full-quality version of the audio can be stored so that the unmasking can involve accessing the full-quality audio in place of the masked audio. In another approach, masked audio can be processed to recover the full-quality audio.

In one approach, access to the unmasking process is based on permissions. For example, an owner may have permission to access both versions while another user does not. Moreover, access to the unmasking process can be limited to a time period encompassing the event.

FIG. 47 depicts a UI 4700 in a first step of an unmasking use case, in accordance with various embodiments. The UI includes the current video feed 4710 which is masked based on the medium privacy level. A time line 4720 includes a message 4721 indicating that a person is detected at a specific point in the time line. A button 4722 to unmask an event is greyed out, indicating it cannot be selected.

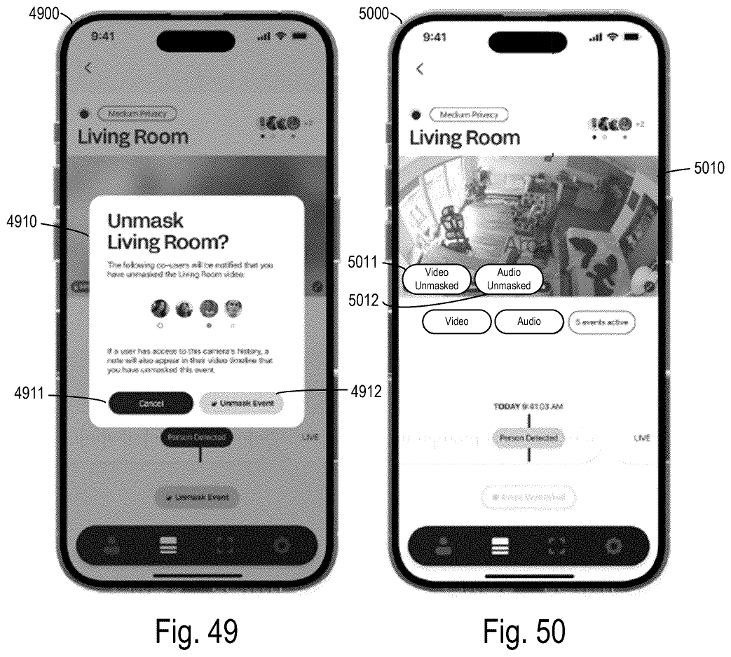

FIG. 48 depicts a UI 4800 in a second step of an unmasking use case, in accordance with various embodiments. The user can scroll the time line or the message 4721 until the current time is aligned with the message. At this time, the message 4721 changes color to indicate the alignment. Also, the button 4722 to unmask the event changes from a greyed out state to a colored state to indicate that it can be selected by the user. Based on the user touching the button 4722, the unmasking starts for a portion of the video corresponding to the event, in FIG. 49. For example, the event may be a person being detected in a room.

FIG. 49 depicts a UI 4900 in a third step of an unmasking use case, in accordance with various embodiments. A pop up message 4910 asks the user to confirm that they want to unmask the video of the living room camera. The message identifies the co-users that will be notified that the current user has unmasked the event. The message also notes that if a user has access to this camera's history, a note will also appear in their video timeline indicating that the current user has unmasked the event. A button 4911 can then be selected to cancel the unmasking, or a button 4912 can be selected to unmask the event.

FIG. 50 depicts a UI 5000 in a fourth step of an unmasking use case, in accordance with various embodiments. The UI displays the unmasked video 5010 corresponding to the event. The unmasked video may correspond to a time period encompassing the event, e.g., slightly before and after the event as well as during the event. Messages 5011 and 5012 indicate the video and audio, respectively, are unmasked.

This approach allows a user to selectively unmask a portion of the video, such as a portion corresponding to an event. The process notifies other users and allows the current user to cancel the process as a way of providing social pressure that minimizes the use of unmasking, thereby preserving the privacy of those captured in the video.

In sum, the above-mentioned solutions provide a number of features that can be further understood in view of the following.

### A First Feature Involves an N-state Unambiguous State Indication System (N>=3).

The N-state indication system is a cluster of privacy features that clearly communicates the sensing status of a smart camera to nearby actors, including camera owners, household members, visitors, and bystanders (adjacent users). The N-state indication system may be used with indoor wired and battery-powered smart cameras, including those used to monitor pets, kids, guests, and domestic workers. The privacy features of the N-state indication system may include visual and auditory indicators that may be on device (e.g., camera unit) and/or displayed on a software application used to control the smart camera. The privacy features may further include a physical and/or virtual lens cover.

The N-state indication system provides an unambiguous mapping between indicator and system states for a True On/True Off/In-between system with at least one In-Between (intermediate) privacy level. The system establishes (1) an absolute floor of capabilities (True Off), (2) a ceiling of capabilities (True On), and (3) at least one In-Between privacy state that is a proper subset of the capabilities within True On.

When the True Off Indicator is active, the system is not utilizing and cannot utilize any sensing capabilities (or other data processing capabilities, etc.)

When the True On Indicator is active, the system is utilizing or can start utilizing any and all capabilities within the total set of functional capabilities {X}. A weaker definition of On can be used, which is simply a set of functional capabilities {z}.

When an In-Between (Privacy State) Indicator is set, the system is not utilizing and cannot utilize a proper subset of capabilities within {X}; instead, it can only utilize a proper subset {X-Y}, where Y is not null.

For improved trust, this system can be implemented with an unambiguous N-state On/Off/In-between indication system involving a True On, True Off, and at least one In-Between state. An unambiguous indication system is defined as a 1:1 mapping between states and indications that is consistent and reliable; no mixed or conflated indication states are possible; variant visual indicators can be used (e.g., high-visibility and low-visibility), but indicators cannot be disabled, radically customized, or conflated/combined).

The solutions herein avoid the disadvantages of systems that use an unlit on-device (or nearby indicator) to signal multiple states, such as True Off and a privacy state or reduced capability state. This is ambiguous since the device can be truly off, or it can be malfunctioning, have lost power, or be in some other limited-capability state.

The solutions herein can include a privacy indicator light that involves more than one privacy state, displays an ordered spectrum of more and less private states, and redefines “privacy state” as a matter of capability reduction. The approach creates a floor and ceiling of capabilities, plus at least one In-Between state with partial capabilities.

The solutions herein can be structured around features including: (1) an application control panel that empowers users to better control, understand, and share their cameras; (2) clearer state indicators for “on” and “off,” called True On and True Off′ (3) Partial (Medium) Privacy and Strong Privacy modes that allow users to achieve useful compromises between privacy and functionality, and (4) a more customizable and granular Shared Access feature that allows access ranging from full and equal co-user access to partial and temporary guest access. In some contexts, ambiguous state indication has advantages to one or more party. To accommodate these needs, a dedicated indicator may also be included that indicates that any of several states may be active (True On, Medium Privacy, Strong Privacy, etc.). When the ambiguous indicator is lit, users would know that the system could be in any of these states. Conversely, when an indicator other than the ambiguous indicator is lit, users would know that only that specific state indicated was active.

There are three main ways for users to control the privacy states.

### 1. Remote Control via Application User Interface (UI)

Camera owners or invited guests can set/change the privacy states of the camera remotely via an application UI.

### 2. Manually via Physical Device Control

If enabled by the camera owner, a nearby user can touch the rim of the camera to close it. Camera owners can explain this hidden closing feature to guests and household members.

### 3. Automatically via Intelligent Privacy State Rules.

Owners can configure advanced rules to automatically schedule or intelligently trigger the privacy states based on events. For example, users can configure cameras to close when a household member's face is detected, close when nudity is detected, or open when smoke or breaking glass is detected.

Advanced Closing Rules and Situational Indicators—Several additional features allow even greater control.

### 4. Repositioning Rules and Alerts

Cameras can be configured to close and/or notify users if moved or repositioned.

### 5. No-Sense Zones

No-Sense Zones automatically activate closed mode when a camera enters off-limits areas. Owners can configure geofenced No-Sense Zones around sensitive areas such as bedrooms, bathrooms, and guest rooms. This feature is especially useful for managing mobile battery-powered smart cameras. It may also be useful for integrated mobile, autonomous, and wearable cameras.

### 6. Still Sensing Reminders

Even with the visual state indicators, people may still forget or not realize that a camera is active. Still Sensing Reminders audibly chirp and visibly flicker to announce to those nearby that there is a live camera. For example, an owner may configure a camera to trigger a Still Sensing Reminder when a household member first arrives home. This can help household members remember to turn a camera off and help guests or domestic workers locate cameras the owners have invited them to disable.

### State-Transition Indicators

In some embodiments, the system may include one or more state-transition indicators configured to signal that the device is about to change, is in the process of changing, or has recently changed an operational or privacy state. Such state-transition indicators may employ dedicated visual, audible, and/or tactile patterns, such as light animations or sound sequences, to notify nearby users of an impending, ongoing, or completed transition between states, for example from a higher privacy level to a lower privacy level.

While the foregoing description emphasizes embodiments involving three or more operational states—such as a maximum capability ceiling, a minimum capability floor, and at least one intermediate state—it should be understood that the disclosed trust architecture, indicator binding mechanisms, and verification techniques are not limited to such configurations. In particular, systems involving fewer or differently structured state spaces may also benefit from and implement the disclosed techniques.

### Two-State (Binary) Systems

In some embodiments, the plurality of system states may consist of only two states, including a maximum operational state and a minimum non-operational state. For example, a sensing system may be configured to operate either in a fully enabled state (e.g., “true on”) or a fully disabled state (e.g., “true off”), without any intermediate gradations of capability. In such embodiments, the disclosed mechanisms for binding system configuration to one or more indicators, logs, or verifiable attestations may still be applied to ensure correspondence integrity, prevent deceptive signaling, and enable third-party verification of the system's current state. Accordingly, the absence of intermediate states does not preclude the use of the disclosed trust architecture.

### Systems with Unrealizable or Absent Capability States

In some embodiments, a system may define or reference one or more theoretical or unrealizable capability states (phantom states) that are not physically supported by the device. For example, a camera system may lack high-resolution image sensors, video recording functionality, or long-term storage capabilities, such that certain feared or assumed capabilities are structurally impossible. In such cases, the system's maximum operational state may itself represent a reduced or constrained capability relative to a hypothetical or unrealizable ceiling, while a minimum state may correspond to full deactivation of sensing and processing functions.

In these embodiments, the disclosed trust architecture may be used to attest not only to the current operational configuration of the system, but also to the absence of certain classes of capability. The system may provide indicators, declarations, or verifiable proofs that specific sensing, processing, or recording functions are not present, not enabled, or not physically realizable. Such embodiments may be particularly advantageous in contexts where trust depends on demonstrating the impossibility of certain actions, rather than merely their current disablement.

### Shared Indicator Representations Across Multiple States

In some embodiments, multiple internal system states may correspond to a common indicator output. For example, a maximum operational state may be associated with a dedicated or distinct indicator, while one or more intermediate states and a minimum state may share a common “inactive” or reduced-capability indicator. In such configurations, the indicator is not required to uniquely encode every internal system state, provided that the indicator does not represent a capability exceeding the system's actual configuration.

In these embodiments, the disclosed trust architecture may ensure that the shared indicator remains truthful with respect to the system's effective capability envelope, while more granular distinctions among internal states may be recorded, logged, or made verifiable through other mechanisms. This approach may be advantageous in systems that prioritize simplicity of signaling, regulatory compliance, or user comprehension, while still supporting robust verification and accountability.

### A second Feature Involves Customizable in-Between States (With Floors and Ceilings, and Unambiguous Indication Systems)

The ideas above for a floor and ceiling can be recursively applied within an In-Between privacy state. This allows a user to customize the capabilities that are currently active or that can be activated (automatically or manually) while in a given privacy state.

### A Third Feature Involves Combining the First and Second Features

This combining creates customized capabilities within a floor and ceiling. For example, a state may caption an image using AI/Machine Learning (ML) image/audio/video analytics, then discard the image/audio recordings, and disallow any additional capabilities other than access to image captions.

A proper subset of this functionality could also be selected, such as “only allow the use of frames that do not involve faces, or a particular face” or “restrict face detection to only a certain areas of the field of view (FOV)” or “restrict frame detection to given time period.”

### A Fourth Feature Involves Custom Sharing Permissions, Including System Status View Sharing

Instead of a one-size-fits-all approach to sharing, the solutions herein can allow users to customize who they do (or do not) share access with across multiple permission tiers. Options range from equal Co-Owner to a limited Status View that enables neighbors, tenants, workers, or other adjacent users to verify and identify the device location, enforced privacy mode, or capability state without granting access to sensor data or control interfaces. Such differentiated sharing supports correspondence integrity by allowing limited but verifiable disclosure of system state information to non-owners in a manner that is proportionate to their role. See also the discussion in connection with FIGS. 41-43.

A Fifth Feature Involves an Open/Closed Indicator Metaphor for use With Point Light or low-Pixel Displays.

Coupled with the first and second features, a system is provided for mapping True On, True Off, and In-Between Privacy States to space-, power-, and cost-constrained LED or similar “low pixel” displays (e.g., e-ink, organic light-emitting diode (OLED), electromechanical). This system allows for multiple implementations that utilize a “more/less” or “open/closed” visual metaphor.

This can be quantified and implemented in many ways. One possible design involves a longer privacy indicator corresponding to a “more on” (less private) state, and a shorter privacy indicator corresponding to a relatively “more closed” (more private) state.

FIGS. 10-22, discussed above, show examples of how the open/close or more/less mental model metaphor can be mapped to various form factors and visual indicators. Audio indication mappings are also possible (e.g., using pitch or tone).

Example of applications to other form factors were also discussed in connection with FIGS. 27-30.

### A Sixth Feature Involves Overlay Indicators

The system may use physical overlays atop a camera or microphone opening (or other sensor, such as LIDAR or GPS) that alters the data (e.g., color tints or blurs video, muffles audio) and provides a visual/tactical indication state for adjacent/primary/nearby users.

Generally, a “True Off” or “Very Off” overlay can be provided, e.g., as a webcam cover with an automated or manual activation mechanism. In contrast, the solutions herein can employ multiple states along a spectrum (e.g., a True Off cover that blocks everything, a colored, tinted and/or textured cover that blocks some data, and no cover that allows everything). See also the discussion in connection with FIGS. 23-26B for camera overlays.

Audio overlays are also possible using audible or inaudible sound interference. Light or electromagnetic radiation can also be used (e.g., infrared). For other sensors, other overlays are possible. A Faraday cage can be used for GPS or networked communications, for example.

The solution can improve over basic automated webcam covers by including multiple states, and using optical tinting/texturing/coloring to alter both the sensor data and resulting image/audio quality and to optically/haptically communicate to nearby primary or adjacent users that the device is in a different state, e.g., a privacy state=reduced capability state.

### A Seventh Feature Involves Custom Privacy/Control Zones

The above states and indications can be selectively applied only to specific aspects of the data or sensor, such as part of a camera's field of view (FOV) and/or display of that FOV, or only to specific AI/ML detected events (e.g., when faces are detected), or to schedules like time of day or locations, and any number of other data or manually set parameters. For example, FIGS. 45 and 46 show an example of True On, True Off, and In-Between custom privacy/control zone states applied to part of a cameras FOV. Share permissions and notification can also be applied selectively (e.g., only sharing part of the FOV with a neighbor, along with state indications).

An Eighth Feature Involves Triggers and Rules for Custom Mode Switching

Mode switching and indication updating can be automated. For example, a Strong Privacy state can be automatically switched to a True On state if a face or a specific person's face is detected.

This can also be automatically changed based on other data (a schedule, time, date, location, etc.). Deliberate gestures could also be use (e.g., waving, smiling, face identification). This can greatly increase the utility of In-Between states by allowing users to ensure a device switches to the appropriate mode depending on context/needs and other inferred or pre-determined information.

A Ninth Feature Involves Binding the Enforced Device Capabilities, Human-Perceptible Indicators, and System Records Into a Unified Architecture Such That These Elements Cannot Diverge, Contradict, or Misrepresent on Another.

As described herein, a sensing device (e.g., a smart camera) supports a plurality of ordered capability states, including a maximum capability state, a minimum capability state, and one or more intermediate capability states. The system is configured to bind (i) the enforced operational capabilities of the device, (ii) the indicator representations presented to users, and (iii) records of state changes and enforcement events, such that no component may independently represent or imply a capability state that is not actually enforced.

The device includes one or more sensing components configured to collect information from an environment, along with processing, storage, inference, and communication components that together define the full set of potential system capabilities.

A primary user or authorized system component may select among different capability states (for example, full sensing, limited sensing, or no sensing). In some embodiments, the system further provides a verifiable representation that one or more capabilities are structurally absent or technically impossible for the device and cannot be enabled in any capability state.

Each capability state defines a hard upper bound on permitted system behavior, establishing a capability ceiling that constraints one or more of sensing, access, processing, storage, inference, or communication functions. These limits are defined such that higher capability states are strictly subsumed by lower capability states, except where a capability is declared structurally absent.

The device automatically enforces the capability limits associated with the selected capability state. Enforcement may be implementing using or more of hardware gating mechanisms, firmware-level controls, operating-system isolation, secure execution environments, application-level policy enforcement, or combinations thereof, such that the sensing system is technically prevented from exceeding the permitted capabilities of the enforced state.

The device further includes one or more human-perceptible indicators—such as visual, audible, tactile, or off-device representations—that are configured to present a representation corresponding to the currently enforced capability state.

The system is constructed such that an indicator representation corresponding to a given capability state cannot be presented unless the corresponding capability limits are already enforced. Conversely, enforcement of a capability state cannot occur without causing the indicator to transition to a representation associated with that state. The indicator control logic and the capability-enforcement logic are physically, electrically, or cryptographically bound together to ensure bidirectional correspondence.

The device maintains a tamper-evident record that logs state transitions and enforcement events, including at least: (i) changes to the enforced capability state, (ii) the corresponding indicator representation presented at the time of each change, and (iii) any detected attempt to disable, bypass, or misrepresent the enforced limits or indicator behavior.

Each record entry may be cryptographically protected—such as by digital signatures, chained hashes, or secure-element attestation—so that modification, deletion, or reordering of records can be detected.

The system provides one or more verification interfaces that allow non-owner users (such as adjacent user guests or bystanders) to verify a current enforced capability state, a guaranteed capability limit, or a historical sequence of states, without granting access to sensor data, control interfaces, or higher-capability functions (e.g., viewing video or audio recordings).

Together, the ordered capability states, the bound indicator representations, and the tamper-evident records form a single integrated system. Upon any state transition, enforcement of the corresponding capability limits occurs, and a verifiable record of the transition is generated. In some embodiments, logging may be optional or selectively enabled, recognizing that logging can introduce computational, time-lag, storage, or regulatory considerations, while the binding between enforcement and indication remains mandatory.

This architecture renders the sensing device's operational behavior—including both enabled and absent capabilities—externally perceptible, technically enforced, and provable to affected users, thereby preventing misleading representations and supporting trustworthy interpretation of device state.

### A Tenth Feature Involves a Correspondence Integrity

This feature involves defining and enforcing a trustworthy, consistent, and non-misleading mapping between internal capability-reduction states of a sensing system and one or more human-perceptible indicator representations. Relative Reduction in Capability (RRC) states represent enforced operational conditions in which one or more sensing, processing, storage, inference, or communication capabilities are reduced, limited, or disabled relative to a defined maximum capability state. Correspondence integrity requires that each externally presented indication accurately reflects the enforced RRC state and does not imply the availability or absence of capabilities beyond those actually permitted by the system.

In various embodiments, particular care is taken in the interpretation and use of inactive indicator states, such as unlit lights, absent visual elements, non-signaling default conditions, or appearance resulting from loss of power. While inactive indicators may be desirable in some contexts due to their inconspicuous, low-distraction, and privacy-preserving nature, improper use of inactive indicator states is a common source of correspondence integrity failures in existing sensing systems. In particular, correspondence integrity may be violated when a single inactive indicator state ambiguously represents multiple materially different capability conditions, such as a fully inactive sensing state, a reduce-capability state, an indeterminate or transitional state, a malfunction condition, or an active sensing state that is simply not externally disclosed. In such cases, nearby users cannot reliably infer enforced or absent capabilities, and the indicator no longer provides a trustworthy mapping to the system's operational behavior. Accordingly, in the systems described herein, an inactive indicator state is treated as an explicit and governed representational state rather than as a default or residual condition. An inactive indicator may correspond to a defined capability floor, to a specific reduced-capability state, or to an explicitly declared indeterminate state, but only when the underlying system is enforceably constrained to prevent any capabilities inconsistent with that representation. Where such enforcement or declaration is not possible, a distinct active indicator attribute, indeterminate indicator, or phantom capability attestation is employed to preserve correspondence integrity.

In some embodiments, correspondence integrity is achieved by defining a finite set of RRC states and associating each RRC state with one or more permitted indicator representations according to predefined mapping rules. The mapping rules constrain which indicator patterns, modalities, or configurations may be presented for a given RRC state and prohibit indicator representations that would overstate, understate, or ambiguously represent the enforced capability limits.

Correspondence integrity is maintained even when different indicator variants are used, such as high-visibility and low-visibility representations, on-device and off-device indicators, or visual, audible, and tactile modalities. While such variants may differ in form, salience, or presentation context, they are required to encode the same underlying RRC state information and to preserve a consistent semantic meaning with respect to capability reduction.

In some embodiments, correspondence integrity further requires that indicator representations change only in response to actual changes in the enforced RRC state, and not merely in response to user interface actions, preferences, or presentation-layer logic. As a result, an indicator cannot transition to a representation corresponding to a lower or higher capability state unless the system has already enforced the corresponding RRC constraints.

By enforcing correspondence integrity, the system avoids conditions in which indicators suggest that sensing or data processing capabilities are enabled when they are not, or disabled when they are in fact available. This prevents misleading representations during partial capability reduction, transitional states, or maximum capability floors and ceilings (e.g., “True On” and “True Off”) and enables adjacent users and primary users to reliably infer the operational constraints of the sensing system based on the presented indicators.

In some embodiments, a plurality of in-between capability states may exist between a defined maximum capability state and a defined minimum capability state, without a logical, ordinal, or intuitive ordering among the in-between states themselves. For example, multiple relative reduction in capability (RRC) states may each restrict different subsets of sensing, processing, storage, inference, or communication functions, such that no single state can be meaningfully characterized as more or less private than another.

In such embodiments, the system may represent all such in-between states as belonging to a common semantic category that is distinct from both the maximum capability state and the minimum capability state. Rather than encoding an ordered progression, the indicator system may communicate that the device is operating in an in-between state while differentiating among the specific in-between states using one or more secondary indicator attributes.

For example, the system may employ a first indicator attribute to signify whether the device is operating at the maximum capability state, the minimum capability state, or an in-between capability state, and a second indicator attribute to distinguish among different in-between states. The first attribute may include indicator placement, shape, illumination extent, or presence or absence of a particular indicator element, while the second attribute may include variations in color, pattern, animation, sound, or tactile feedback.

In this manner, the indicator system communicates that all such in-between states represent partial capability reduction relative to the maximum capability state, while avoiding the implication of a false ordering among them. Correspondence integrity is preserved because each indicator representation remains uniquely and consistently bound to its associated RRC state, and no indicator suggests that one in-between state provides greater or lesser capability reduction unless such an ordering is explicitly defined by the system.

In some embodiments, enforcement of a capability state and update of corresponding indicator may not occur simultaneously due to processing latency, communication delay, power-state transitions, or verification operations. Such delays do not necessarily defeat correspondence integrity provided that: (i) the delay is bounded and transient; (ii) the system converges to a consistent enforced state-indicator pairing; and (ii) during any interval in which correspondence cannot yet be guaranteed, the system refrains from presenting an indicator that would imply enforcement of a capability state that has not yet been fully enforced.

In some embodiments, the system enforces a directional correspondence constraint in which transitions to lower-capability states may occur without immediate modification of the indicator representation, provided that transitions to higher-capability states are prohibited unless and until the indicator representation is updated to reflect the enhanced capability state. Such embodiments prioritize avoidance of misleading overstatement of sensing or data processing capabilities. A temporary indication that overstates privacy relative to actual enforced capability reduction does not create increase sensing risk, whereas an indication that understates sensing capability could mislead adjacent users regarding exposure. In such embodiments, prolonged or persistent divergence between indicator state and enforced capability state is avoided, and the system is configured to reestablished full correspondence once synchronization, verification, or enforcement operations complete.

In an extreme but valid embodiment, the indicator system may employ a minimal set of indicator states in which an inactive indicator condition (such as an unlit light-emitting element) represents the minimum capability state, an active indicator condition represents the maximum capability state, and one or more additional indicator attributes are used to represent in-between capability states. For example, an unlit indicator may correspond to a True Off state in which all sensing and related capabilities are enforceably disabled, while a lit indicator corresponds to a True On state in which full capabilities are enabled. One or more in-between states may be represented using a secondary attribute—such as color, pattern, modulation, location, or auxiliary indicator element—while the primary indicator remains active.

In such embodiments, correspondence integrity is maintained provided that the system is technically and enforceably prevented from employing any sensing, processing, storage, inference, or communication capabilities when the indicator is in the inactive condition. That is, the inactive indicator condition must be uniquely and exclusively associated with a capability floor state, such that the device cannot operate in any in-between or active capability state while presenting the inactive indicator representation.

In another extreme but valid embodiment, an inactive indicator condition may be used to represent an in-between capability state rather than the minimum or maximum capability state. For example, an unlit indicator may correspond to a reduced-capability privacy state in which limited functions such as event detection or facial recognition are enabled while full sensing, recording, or data transmission capabilities remain disabled. In such an embodiment, a lit indicator—such as a green illumination—may represent a maximum capability state (True On), while a distinct third indicator attribute is used to represent the minimum capability state (True Off).

The minimum capability state in such embodiments may be indicated using a power-independent or mechanically enforced indicator, such as a spring-biased cover, shutter, or other passive indicator element that visibly changes state upon loss of power and remains invariant while the device is incapable of sensing. In this configuration, correspondence integrity is maintained because each indicator condition—active illumination, inactive illumination, and passive mechanical indication—is uniquely bound to a specific enforced capability state, and no indicator condition is reused to represent multiple capability states without a distinguishing attribute that preserves unambiguous interpretation.

In another extreme embodiment, the system may be architected such that no active indicator is used to represent a maximum or intermediate capability state beyond a limited privacy-preserving function, and no dedicated physical indicator is used to represent a broader minimum capability set. Instead, the system may employ a phantom indicator that attests to the enforced absence of all capabilities other than those explicitly permitted.

In such embodiments, the device may be operable only in one of two enforced conditions: (i) a constrained privacy mode in which a narrowly defined capability—such as local biometric verification, facial recognition for identity confirmation, or another limited function—is enabled, or (ii) a True Off state in which all sensing, processing, storage, inference, and communication capabilities are disabled. The phantom indicator does not present a direct perceptible signal corresponding to an active sensing state, but instead attests—through system guarantees, verification mechanisms, or absence-of-capability proofs—that no additional capabilities beyond the constrained privacy mode are present or possible.

In this configuration, correspondence integrity is maintained because the system is architecturally and enforceably incapable of performing unrepresented capabilities, such as video recording, audio recording, or data transmission, regardless of indicator presentation. The phantom indicator thereby communicates not the presence of a specific capability, but the provable impossibility of capabilities, ensuring that adjacent users are not misled by the absence of a visible indicator into assuming functionality that the device cannot, by design, possess.

In such embodiments, the phantom indicator may eliminate the need for a maximum-capability (ceiling) indicator by attesting that the corresponding capability state is architecturally unavailable and cannot be entered by the device.

### An Eleventh Feature Involves Real-Time Tests and Challenge-Response

This feature enables a user, including an adjacent or non-owner user, to actively verify one or more attributes of a sensing device, such as device identity, physical location, field of view, operational state, enabled capabilities, privacy states, or phantom capabilities. Verification may be performed using real-time interactions between a personal computing device associated with the user and the sensing device. Such interactions may include signaling exchanges, partial data disclosures, obfuscated media samples, and cryptographic challenge-response procedures.

The following two real-time tests can be implemented.

A first example test includes a ping-device process in which a user transmits a signal from a personal smart device to a sensing device. In response to receipt of the signal, the sensing device generates a perceptible acknowledgement, such as emitting a sound, flashing a light, or displaying a distinctive indicator pattern. In some embodiments, an expected acknowledgement representation—such as a flashing pattern, symbol, or numeric code—is concurrently presented on the user's personal smart device, enabling the user to visually or otherwise compare the expected acknowledgement with the response observed on the sensing device for verification. This acknowledgement establishes a live association between the user′ s request and the physical device, allowing the user to confirm that capability information, state indicators, or representations presented on the user's device correspond to the correct sensing device and not to a simulated, duplicated, or spoofed object.

A second example test includes a field-of-view (FOV) preview process, in which an adjacent user may request or receive a limited media representation illustrating what the sensing device is currently capturing or has recently captured. The preview may include, for example, a still image, a short video clip, a masked or obfuscated visual sample, or another reduced-fidelity representation consistent with the current privacy mode. This process allows the user to verify the physical placement, orientation, and coverage of the sensing device, such as by positioning themselves within the sensing area and confirming their presence in the preview.

In analogous embodiments, similar real-time verification processes may be implemented for audio or other sensing modalities, including provision of masked or transformed audio samples. In some embodiments, a real-time verification test is performed for audio sensing, in which a user emits a sound or spoken word and the device responds with a corresponding acknowledgement or constrained audio representation, allowing verification of microphone capability, coverage, or operational state. Access to such previews or verification responses may be conditioned on authentication, authorization, proximity-based validation, geofencing constraints, or permission checks such that only users granted an appropriate access level, identity, or location (e.g., proximity to the sensor device) may request or receive the corresponding information.

### A Twelfth Feature Involves Attestation of Absent Capability and Phantom States

This involves proving that certain capabilities are impossible, even if users assume they do or may exist based on available hardware, software, product category, or device appearance (e.g., has a power cord, has indicator lights). These are referred to as phantom states or capabilities. Whereas a normal capability state is what a device is allowed to do right now, a phantom state is something a device can never do, regardless of its current state. This expands the architecture to these main types: Fully enabled (True On=absolute ceiling), Relative reduction in capability, Disabled (True Off=absolute floor=fully reduced capability), and Impossible (capability does not exist and cannot be enabled).

In some versions, the system is configured to indicate, attest, and share verification of capabilities that are structurally impossible for the device. These phantom capability states are treated similar to RRCs: they are bound to human-perceptible indicators, cryptographically verifiable logs, and non-owner verification interfaces, and remain invariant across all configuration states. Similar to how RRCs are handled, selective disclosure is preserved when sharing and displaying phantom states. Phantom state sharing does not expose firmware, control interfaces, or other capabilities or data. They allow the absence of a capability to be attestable and auditable.

Whereas RRCs are selectable, enforced, and can change over time, phantom states are structural, permanent, and attested as such.

Existing systems focus on controlling or limiting capabilities that exist. They do not provide technical mechanisms for proving that a capability is absent or impossible, leaving nearby users to assume worst-case sensing and data collection.

### Structural Hardware Absence

In one embodiment, a phantom capability is attested based on the physical absence of required hardware components. For example, a device may lack a microphone, camera, infrared emitter, depth sensor, radio transceiver, or dedicated processing unit required to perform a particular sensing, inference, or communication function. During manufacturing or provisioning, the device records a hardware configuration descriptor indicating the absence of such components. This descriptor may be stored, for example, in non-volatile memory or a secure element, and cryptographically bound to a device identifier. Because the required hardware is physically absent, the corresponding capability is structurally impossible and cannot be enabled in any operational state.

### One-Time Fused or Permanently Disabled Hardware Paths

In another embodiment, a phantom capability is enforced and attested through irreversible hardware modification. For example, conductive traces or power rails associated with a capability may be permanently severed, fused, or disabled during manufacturing, provisioning, or certification. Such irreversible modification may be implemented using hardware fuses, laser cutting, blown links, or permanent configuration bits. The system records an attestation that the capability has been permanently disabled and cannot be restored through software, firmware updates, or configuration changes.

### Immutable Firmware or Boot-Chain Attestation

In some embodiments, a phantom capability is enforced by the absence of executable code paths required to enable the capability. For example, firmware or drivers necessary to operate a sensor, communication, or processing function may be permanently omitted from the device's trusted boot chain. A secure boot mechanism verifies that only signed firmware images without the phantom capability are loadable. The absence of the capability can be attested by cryptographically signing a manifest of supported and unsupported functions during boot, such that the device can prove that no executable path exists for enabling a phantom capability.

### Secure Element or Trusted Execution Environment (TEE) Attestation

In one embodiment, a secure element or trusted execution environment maintains an immutable register indicating phantom capabilities. The register is initialized at manufacturing or certification time and is readable for attestation but not writable during normal operation. When responding to a verification request, the secure element produces a signed statement indicating that a particular capability is structurally absent. Because the attestation originates from isolated hardware, it is resistant to spoofing by application-level software. This can be used, for example, to attest to the absence of video recording or facial recognition capabilities for a device that has an onboard camera sensor.

### Cryptographic Proof of Phantom Capability

In some embodiments, the system provides cryptographic attestation of phantom capability by generating a signed statement asserting that no private key, certificate, firmware module, or hardware identifier corresponding to a capability exists on the device. This may allow the system to attest absence without exposing internal architecture or control interfaces.

### Indicating Phantom Capability

In one embodiment, phantom capabilities are bound to one or more human-perceptible indicators in a manner similar to enforced RRC states. For example, a distinct indicator pattern, color, symbol, or display state may communicate that a particular capability is impossible rather than merely disabled. The indicator may be invariant across all operational states, such that the same phantom capability indication is presented regardless of configuration changes. The device is configured such that the phantom indicator cannot be altered unless the underlying structural condition changes, which is impossible under normal operation.

### Logging and Temporal Invariance

In some embodiments, the system records a tamper-evident log entry indicating the presence of one or more phantom capabilities at initialization or certification time. Unlike RRC state transitions, phantom capability log entries do not change during the normal lifetime of the device. Subsequent log entries may reference the phantom capability status to demonstrate that all operational states occurred while the capability remained absent. This allows third parties to audit historical device behavior with respect to both enforced and impossible capabilities.

### Non-Owner Verification of Phantom Capability

In one embodiment, the system provides non-owner users with a verification interface that allows them to confirm that a capability is structurally absent without granting access to sensor data, firmware, or configuration controls. For example, a nearby user may query the device via a wireless interface and receive a signed response indicating that a specific sensing or recording capability is impossible. The response may be accompanied by a human-perceptible acknowledgment, such as a distinct light pattern or audible signal, to establish correspondence between the digital attestation and the physical device.

### Selective Disclosure of Phantom Capability

In some embodiments, the system supports selective disclosure of phantom capabilities. For example, a device may attest that it lacks audio recording capability without revealing other supported or unsupported capabilities. This selective disclosure preserves security and privacy while allowing adjacent users to verify the absence of specific functions relevant to their concerns.

### Phantom Capability in Multi-Sensor or Modular Devices

For devices with multiple sensors or modular components, phantom capability attestation may be applied on a per-sensor or per-module basis. For example, a device may attest that audio capture is impossible while still supporting video capture, or that high-resolution video capture is impossible, but low-resolution video capture is possible. Each phantom capability may be independently bound to indicators, logs, and verification mechanisms.

### Relationship Between Phantom Capability and RRC States

In all embodiments, phantom capability states differ from relative reduction in capability (RRC) states in that phantom capabilities are invariant, non-selectable, and permanently phantom under normal operation. RRC states define ceilings on capabilities that exist but are temporarily limited, whereas phantom states define capabilities that cannot be enabled in any state. The system architecture treats both as attested properties but enforces different temporal and configurational constraints. For example, in one embodiment, a non-owner verification interface displays both absent capabilities (immutable under normal operating conditions) and RRC states (mutable).

### A Thirteenth Feature Involves On-Device, Near-Device, and Off-Device Indicators

This feature involves presenting capability-state indications using one or more indicators that may be physically integrated into a sensing device (on-device), positioned in spatial proximity to the sensing device (near-device), or presented via a separate local or remote system (off-device). As used herein, indicators comprise human-perceptible representations that communicate enforced, limited, or absent sensing, processing, storage, or communication capabilities of the device.

On-device indicators are physically incorporated into the housing or structure of the sensing device and are positioned in close proximity to one or more sensors or sensing components. Near-device indicators comprise separate indicator units that are spatially associated with the sensing device and configured to augment, mirror, or otherwise convey the same capability-state information, such as a companion display mounted on, adjacent to, or within a predefined distance of a camera or other sensor. Off-device indicators present capability-state information on one or more external systems, such as mobile devices, local computing devices, or network-accessible interfaces, while remaining logically and operationally bound to the enforced capability state of the sensing device.

In various embodiments, on-device, near-device, and off-device indicators may be used individually or in combination. When multiple indicators are employed, the system maintains correspondence integrity by ensuring that all presented indications consistently and accurately reflect the same underlying enforced capability state of the sensing device.

In one illustrative embodiment, a wearable sensing device—such as smart glasses—may broadcast a short-range beacon indicating an enforced capability state of one or more onboard sensors, including camera and microphone activation. A nearby wearable device associated with another user (for example, another pair of smart glasses, a smart watch, a smart phone, or another wearable computing device) may receive the beacon and generate a discreet, human-perceptible notification, such as a haptic vibration, to alert the wearer that an active sensing device is present. Upon receiving the notification, the receiving device may present a corresponding indication within a notification center or status interface that summarizes the sensing device's current capability state (e.g., camera active, microphone active, reduced-capability mode, or absence of a camera as a phantom state), optionally including verification or attestation information. This enables socially appropriate, low disruption awareness of sensing activity in proximate interpersonal interactions without requiring visual inspection of the sensing device itself.

### A Fourteenth Feature Involves an Indeterminate State Indicator

The Indeterminate State Indicator comprises a dedicated indicator representation configured to signal that the operational or privacy state of a device is indeterminate or not definitively known at a given time. In such a state, the device may be fully active, fully inactive, or operating in an intermediate or transitional condition. The Indeterminate State Indicator enables a device owner or system to accurately communicate uncertainty regarding the current state, rather than presenting a potentially misleading indication of a specific state.

In some embodiments, the Indeterminate State Indicator may be used to preserve correspondence integrity by avoiding representations that imply a definite state when such a state has not been established, verified, or enforced. For example, the indicator may be presented when the system cannot guarantee whether sensing, recording, processing, or communication capabilities are enabled or disabled. A user may intentionally select presentation of an Indeterminate State Indicator even when the operational or privacy state of the system is known to the user. For example, this may allow the user to convey to adjacent users that the system may be active, without disclosing which specific state, if any, is currently active.

In some embodiments, the Indeterminate State Indicator may be intentionally selected or configured by a user. For example, a user may choose to present an indeterminate indication to suggest that a device may be active without disclosing its precise operational state, such as to deter unwanted activity when the user is away, while selectively presenting a determinate state indication in other contexts.

In additional embodiments, indeterminate states may be automatically employed during enforcement, verification, attestation, or synchronization processes that require time to complete. During such processes, no definitive capability state may yet be enforced or verified. The Indeterminate State Indicator allows the system to accurately represent this condition while a state transition is pending or being validated. By contrast, systems that present a determinate state during such periods may inaccurately imply that a state change has already taken effect when it has not.

### Additional Details About Configuring, Combining, and Implementing Some of the Features Discussed Above

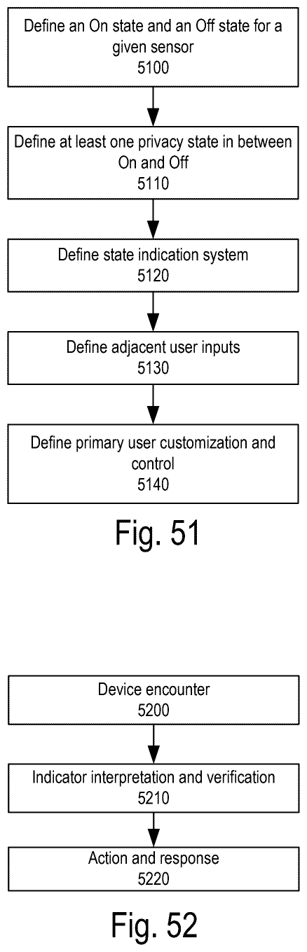

The flowcharts of FIGS. 51 and 52 provide processes with additional details about configuring, combining, and implementing some of the features discussed above.

The processes allow primary and backend users to define states in-between True On and Off, and provides a set of tools for defining useful In-Between privacy states. Primary users typically own and operate the sensor unit, e.g., camera unit, and the data processing and display application. Backend users are the system owners, such as a product manufacturer, service provider, or system administrator.

The processes also facilitate trustworthy communication of these states to adjacent users and primary users. Adjacent users can include anyone subjected to the smart sensing system but who have limited access, control, consent, or benefits. Examples include: bystanders, guests, and surveilled subjects. Importantly, primary users may often find themselves occupying the role of adjacent user, even with their own devices (e.g., standing in front of your camera, wondering if it is actually recording you or not).

The processes also support on-device indication using simple, economical and space-constrained digital indicators such as point-light LEDs. This allows indicators to publicly broadcast from the sensor source, without requiring remote application access or other informational materials.

The processes also provide different ways of sharing an information key that explains the privacy state indicators and the technical states they represent.

The processes also allow for concrete actionable responses from adjacent users including controlling the system, requesting changes, or contesting use and settings.

FIG. 51 depicts a flowchart of an example process involving a backend user, in accordance with various embodiments.

Initially, the backend user defines a True On and True Off, which establishes a floor and ceiling of privacy. Then, at least one In-Between state is defined. Then these states are mapped to an indication system that uses the metaphor of more/less or open/closed to create a usable mental model. Other display systems or metaphors can be used instead or in addition to the more/less metaphor, such as custom iconography or text. The system can optionally be configured to allow adjacent users to control, request, or contest changes to the system.

Primary user/device owners may then repeat these steps to further customize the system further, within the parameters established by the backend service provider or system owner/administrator.

Finally, adjacent users can then perceive the privacy indicators, interpret their meaning with the help of shared keys, make informed choices such as leaving the vicinity, and possibly take system action to control, request, or contest settings.

### Backend Configuration: Summary of Steps for Backend User

The initialization of the system is configured by a backend user.

Step 1: Define an On state and an Off state for a given sensor (block 5100).

Step 2: Define at least one privacy state in between On and Off (block 5110).

Step 3: Define State Indication system (block 5120).

Step 4: Define adjacent user input options (block 5130).

Step 5: Define primary user customization and control (block 5140).

### Primary Configuration: Summary of Steps for Primary User

A primary user may be allowed to repeat Steps 1-4 to customize or alter settings, as defined/allowed by the Backend User setup.

### Backend User Configuration

During this initialization phase, the backend user defines the basic functionality of the system and which, if any, aspects can be customized or altered by primary users (e.g., device owners/consumers).

### Step 1: Define an On State and an Off State for the Sensor System (Block 5100)

“On” represents a ceiling, or maximal sensing and/or processing capabilities. “Off” represents the floor, or minimal sensing and/or processing capabilities.

For maximal trust, it is recommended that the system is defined with a “True On” and “True Off.” True Off means that a sensor is completely deactivated and incapable of collecting any data. Hence, no non-trivial data processing is possible. True On means that a system is operating at its maximum sensing capabilities, and may be subject to unlimited data processing, sharing, and storage capabilities.

True Off implies a situation of complete privacy with respect to the sensor system's functionality. Conversely, True On implies a total absence of privacy.

True On indicates that the camera's sensors are fully “open and active:” the device is recording, and any number of event detection states may be active. True Off indicates that the camera sensor is completely deactivated and unable to record video, detect events, or perform any other functions.

Note that defining a maximum data processing (or information extraction) state is challenging given that there is no well-defined upper bound on what can be learned from rich data sources such as video, image, and audio recordings.

Note that correspondence integrity is important for creating unambiguous mapping.

### Step 2: Define at Least one Privacy State in Between On and Off (Block 5110)

A key attribute of this step is the metaphor of a “dimmer switch” for sensor privacy. A core idea is to define a spectrum ranging from True On to True Off. The simplest implementation involves discrete “dimmer states” (rather than a continuous sliding scale).

For example, see FIGS. 1, 3, 5 and 7 which depict a four-state system with two In-Between states, which are called “Medium Privacy” and “Strong Privacy.”

### Step 2a

Determine the number of privacy states In-Between On and Off. For simplicity, consider a 3-state smart camera system. The N-state system is similar, but with a few caveats discussed below. Further, assume this is a True On/Off system. This 3-state system will then have one state in between True On and True Off. Call this state Partial Privacy.

### Step 2b

Define the functionality and privacy claims of the In-Between state. Continuing with the example above, we need to define one Partial Privacy state.

The motivation for defining a privacy state could stem from concerns with privacy. Alternatively, it could originate with another functional concern, such as conserving power, and it just so happens to also improve privacy relative to a True On state.

Below are some examples of how we could define Partial Privacy:

Sensor switching. When in Partial Privacy, the camera switches to a lower resolution sensor unit, which provides greater privacy.

Mechanical Near Field Interference (NFI). When in Partial Privacy, digitally controlled physical materials are deployed to interfere with the environment in close proximity to the camera lens (or other spatial sensor) with the effect of blocking or modifying data capture in ways that reduce information and may increase privacy. One method is the use of camera lens overlays with varying transparency, tinting, and texturing. For example, Partial Privacy may activate a semi-translucent mechanical shutter that covers the lens, blurring the video feed but still allowing some useful information to be captured, such as images that allow for reliable motion detection from local processing or reliable person detection from cloud-based computer vision. In both cases, the shutter can prevent sufficient resolution for face detection, thus achieving a higher level of privacy while still allowing other useful functionality, namely motion detection or person detection features.

Note that NFI is also possible with other techniques, such as e-ink, lights, sounds, and other electromagnetic radiation.

Example: The present design case study illustrates the use of an NFI shutter (a sensor overlay indicator).

The indicators may be displayed in motion to show a transition from True On (no NFI) to Medium Privacy (yellow tinted NFI) to Strong Privacy (slightly tinted and/or blurred NFI) to True Off (opaque, light/image blocking NFI shutter).

Information reduction/transformation. When in Partial Privacy, the camera system may securely translate raw camera data into functional yet privacy preserving formats. For example, the system may use event detection to translate video into privacy-preserving captions, such as “person detected” or “Adam Smith detected.” Other possibilities include the use of dynamic masking to blur specific objects, such as faces, nudity, text, or people's bodies.

The system could also transform/reduce the image/audio data.

### EXAMPLES

blocking part of the image (such as a neighbor's yard or window)
Reducing the resolution of the image
Applying a blur effect
Applying transformation/reduction to dynamic image segmentation, events (whenever an object is detected, with an option pre or post durational extension), or geofenced areas

Example: The present design case study illustrates information reduction/transformation wherein object recognition algorithms are used to translate video/audio into privacy-preserving captions.

Recall that FIGS. 47-50 provided an example implementation and details for a Medium/Partial Privacy mode with Access Inhibitors that discourage/inhibit access with mechanisms such as elongation and subordination of navigation click-stream and interface layout, along with social accountability (watermarks, notification, logging).

Content display and access. When in Medium Privacy, the camera may restrict how data is presented and who can access the data. For example, Medium/Partial Privacy mode could apply any of the reductions/transformations listed above but still allow users with higher access permissions to retrieve the original video or raw camera data.

Access inhibitors. When in Medium Privacy, the system may enact “speed bumps” that make it more effortful for primary users to access, use, and/or share data but without outright preventing users from doing so. This mode employs behavioral design patterns to inhibit privacy-invasive uses, which research has shown can be highly effective. There are several general patterns that can be effectively used in our contexts. First, the interface can elongate the number of steps required to perform a task (and/or other ways of increasing time and effort). For example, the system may mask video by default. In order to inhibit users from unmasking video, this process can be made cumbersome by requiring users to manually unmask video in 30 second segments, rather than allow them to unmask an entire video history with a single button click. Second, the interface can subordinate functionality by making it less visible or prominent. For example, the system could place the unmasking button deeper in the information hierarchy within a settings menu. Third, the interface can employ social accountability by warning users that their actions will be visible to others. For example, if a user unmasks a video this information could be made available to other users of the system. Or, the video could be watermarked after unmasking as evidence that the system was in a Partial Privacy mode.

Example: The present design case study illustrates each type of Access Inhibitor. Medium Privacy mode adds a removable mask that blurs video and muffles audio. Owners can always unmask video to review events, but other users may be notified. Further, unmasked video is watermarked and the time and user who unmasked the video is visible in the history view. Medium Privacy is designed to discourage you and other co-users from reviewing videos of your household, guests, neighbors, and so on. Unmasking video is a somewhat tedious process, and the unmasking feature holds users socially accountable by notifying other users if video is unmasked. This gives you and your household a double peace of mind. Peeking is discouraged, but it's always an option if something happens.

### Step 2c

For N-state systems where N>3, there will be at least two privacy states in between On and Off. The most important implication of such a system is that there may not be an obvious or intuitive hierarchical ordering among the In-Between states such that they can be arrayed from “most private” to “least private.” If there is not a logical or intuitive privacy ordering, then a separate set of considerations may be desired in Step 3 when defining the state indication system.

### Step 3: Define State Indication System (Block 5120)

State indicators (e.g., privacy indicators) are the mechanisms by which the internal privacy state of the system is represented to users. LED point light indicators are among the most common and economical forms of on-device indication. Other mechanisms include sound from digital speakers, symbols from digital screens, e-ink displays, or haptic/electromechanical feedback.

### Step 3a

Define the on-device indication system. On-device indication refers to the state indicators that reside within or near the sensor unit housing (or other critical components). In many cases, it is not feasible to include high-resolution on-device indicators such as LCD display screens. Instead, a simple array of LED lights (or sounds) is often the only feasible method.

Providing users with economical yet legible on-device indication for smart sensor systems (and IoT in general) is critical for several reasons:
1) Restricted interface access. Full access to most smart sensing systems requires access to a separate interface such as a web-based application or remote client. However, even in situations where primary or authorized backend users wish to offer access to adjacent users it is often not feasible to provide this access to adjacent users for numerous reasons, including cost, security, and expertise.
2) Limited on-device indication. On-device indicator lights and sounds are the most common/economical mechanism for on-device indication. However, they have serious limitations.

Limited screen real-estate and information density. They do not possess the informational density needed to communicate complex and dynamic information. For example, many use a single point light indicator which can only display a handful of states. Communicating dynamically with text, image, or icon is impossible.

One-indicator-for-all. When there is one public display, the information cannot be customized. Further, a diverse array of users may have very different needs. They may also have competing interests. For example, a primary user may wish for a co-user to have full and legible access to state indication. But they may prefer that these indicators are invisible to adjacent users, who may complain when they notice the devices.

Ambiguous indication. Users have little or no way of verifying that external state indicators correspond to internal operation. Low information density point lights are often ambiguous. Even primary users often distrust point light indicators.

In light of these issues, this method recommends the following techniques for defining on-device indication from LED point lights. (Separately, other modalities may be considered including sound and haptics and LCD displays.)

Case 1: There is a logical or intuitive privacy ordering.

In this case, it is recommended that an open/closed or more/less metaphor be employed. Three useful implementations are a continuous bar indicator, a ring/circle indicator, and discrete point-line indicator.

Example: The present design illustrates an intuitive and logical ordering of privacy states ranging from most private to least private: True Off, Strong Privacy, Medium Privacy, and True On. The visual metaphor is a circular arc that lengthens and shortens corresponding to the privacy state. A full circle indicates the least privacy (True). No lights (with a mechanical lens covering) indicates the most privacy (True Off). A half arc or short arc indicate Medium Privacy and Strong privacy respectively.

As discussed, FIGS. 1, 3, 5 and 7 depict an example implementation of a logical and intuitive privacy state ordering from True Off to In-Between states to True On.

This method can be generalized to other form implementations. FIG. 10-22 show other implementations of a logical more/less and open/close privacy state spectrum.

Case 2: There is not a logical or intuitive privacy ordering.

In this case, it is recommended to avoid suggesting an ordering to users. For example, different colors of the “half arc” design could be used to indicate different In-Between states.

Example: Within each In-Between state, The design may not use a more/less metaphor. For example, within Medium Privacy there is an option to only mask specific objects, such as faces, nudity, or text. Since there is not a clear intuitive ordering to these variations, this design instead places them within the clearly ordered category of Partial Privacy.

### Step 3b

Define the remote access indication system. This may include application access. It may also include a broadcasted signal (beacon).

### Step 3c.

Define posted indication. This is simply a key that could be printed and posted nearby, or available online a QR code, public website, or shareable link.

### Step 4: Define Adjacent User Input Options (block 5130)

Notice and request—option for adjacent user to notify and send a request such as sharing status or disabling or switching modes.

Notice and contest—similar to above but escalates to intervening body or authority, such as a local government or the service provider.

Notice and control—similar to above but allows for direct control or request of control.

External controls, such as QR code, gesture, or other sensor-read input/output techniques may also be used.

There are a few ways that these interactions can be performed technically:
In-app, e.g., submit a request form.
on-device input, e.g., a push a button. On-device controls could be remotely enabled/disabled/configured by a primary user or admin.
external controls is when a user performs a gesture, voice and symbolic command using a physical mechanism that is interpreted by the sensor system. Example: presenting a QR code, speaking a paraphrase, presenting a gesture, standing in front of a camera so it can register your face which signals it to switch modes.

### Step 5: Define Primary User Customization and Control (Block 5140)

Any of the above steps could be customized and configured by a primary user, or adjacent user with requisite permissions.

FIG. 52 depicts a flowchart of an example process involving an adjacent user, in accordance with various embodiments.

### Adjacent use: Summary of Steps for an Adjacent User

Step 1: Device encounter (block 5200). An adjacent user encounters a suspected smart sensing device. They notice one or more of the state indicators.
Step 2: Indicator interpretation and verification (block 5210). The user interprets the indicator(s). The adjacent user may need to lookup the key for interpreting the status indicator. There are several methods/user flows in which this can happen.
Case 1: No lookup is necessary. The adjacent user already knows how to interpret the on-device indicators (e.g., LED lights) because of inside knowledge or a universally known indicator meaning.
Case 2: The user has remote/application access, and views the indication key within a software app.
Case 3: The sensor system digitally broadcasts a communication protocol for sharing the key (e.g., a beacon protocol that communicates within a smartphone's OS).
Case 4: The user accesses a shared weblink or public database to access the key. This could be shared personally by the camera owner, e.g., through SMS or a QR code posted nearby. It could also be maintained in a public website/database, e.g., one maintained by a company or government or other trusted entity.
Case 5: The key is printed nearby.
Step 3: Action and response (block 5220).

Base case: external responses, such as relocating one's body, unplugging a device, communicating with a primary user or third party (e.g., law enforcement), or publicly voicing concerns. In most cases, assuming a non-coercive situation, the adjacent user will be able to use the state indication information to make an informed behavioral choice, such as leaving the vicinity of the sensing device. They may also be able to make verbal requests to the camera owner or take direct action, such as unplugging a device or covering it (e.g., in domestic settings). Broader social action is also possible, such as voicing concern publicly or to key stakeholders such as managers or government representatives.

### Internal Responses (Digitally-Mediated by the System)

Depending on the system configuration, the adjacent user may have several courses of internal response facilitated by the system. Some of these features depend on additional infrastructure, such as new laws and policies, device registries, and mediation protocols.

Each of these cases goes beyond the standard “notice and consent” approaches to digital privacy.
Case 1: Request. The adjacent user might request a state change from the device owner, such as switching to True Off. An adjacent user may also be able to request additional information, such as who owns the device and whether the camera is registered to a public or private database.
Case 2: Control. The adjacent user may be able to change the state of a device depending on the permissions set by the primary user. For example, a primary user may grant the ability to switch a device to Partial Privacy. Or, a device may have an on-device control element, such as a mode-switching button that can be activated or deactivated.
Case 3: Contest. The adjacent user may be able to submit a complaint or escalate the concern to a higher authority. For example, if a device is pointed at someone's home, they may be able to contest this use through a mechanism that is reviewed by the service provider company. Alternatively, a public or workplace camera could be contested by employees, citizens, or others. Some implementations of these protocols would require new policies or legislation.

A number of implementations have been described. Nevertheless, it will be understood that various modifications may be made without departing from the spirit and scope of the disclosure. Accordingly, other implementations are within the scope of the following claims.

What is claimed is:

1. An apparatus, comprising:
a sensing component;
a user-perceptible indicator;
a memory configured to store instructions; and
one or more processors coupled to the memory, wherein the one or more processors are configured to execute the instructions to:
select a current privacy state from a plurality of privacy states, the plurality of privacy states including a first privacy state, a second privacy state, and at least one intermediate privacy state between the first and second states; and
control the user-perceptible indicator according to the current privacy state.

2. The apparatus of claim 1, wherein the user-perceptible indicator has a varying length based on the current privacy state.

3. The apparatus of claim 1, wherein:
the user-perceptible indicator comprises a light; and
based on the one or more processors entering a sleep state, the one or more processors are configured to execute the instructions to turn on the light.

4. The apparatus of claim 1, wherein the one or more processors are configured to execute the instructions to:
receive a ping from a smart user device; and
respond to the ping with at least one of a visible or audible acknowledgement.

5. The apparatus of claim 1, wherein the one or more processors are configured to execute the instructions to:
receive a request from a smart user device for a preview of video from the sensing component; and
allow access to the preview based on confirming that the smart user device has been granted permission.

6. The apparatus of claim 1, further comprising a transmitter coupled to the processor, wherein the transmitter is configured to broadcast a wireless signal comprising an identifier of the current privacy state.

7. The apparatus of claim 1, wherein the one or more processors are configured to execute the instructions to:
receive video from the sensing component; and
based on the current privacy state being greater than the first privacy state, reduce a quality of at least a portion of the video by at least one of providing a light-filtering overlay for a lens of the sensing component or processing image data received from the sensing component.

8. The apparatus of claim 1, wherein the one or more processors are configured to execute the instructions to:
receive video from the sensing component; and
based on the current privacy state being greater than the first privacy state, store a full-quality version of the video and a reduced-quality version of the video.

9. The apparatus of claim 1, further comprising:
a spring-biased cover for a lens of the sensing component; and
an electromechanical actuator configured to hold the spring-biased cover away from the lens, wherein the electromechanical actuator is configured to release the spring-biased cover to allow the spring-biased cover to cover the lens in response to a loss of power at the apparatus.

10. The apparatus of claim 1, wherein the one or more processors are configured to execute the instructions to implement a user interface configured to allow a user to define a sharing setting for one or more other users, wherein the sharing setting comprises a permission to at least one of view data from the sensing component, select the current privacy state, or receive a notification based on the current privacy state.

11. An apparatus comprising:
a sensing component;
a user-perceptible indicator;
a memory configured to store instructions; and
one or more processors coupled to the memory, wherein the one or more processors are configured to execute the instructions to:
enforce sensing and processing capability limits corresponding to a selected capability state of a plurality of capability states, wherein the plurality of capability states are arranged along an ordered spectrum of sensing capability and include a maximum capability state, a minimum capability state, and at least one intermediate capability state, and the at least one intermediate capability state enables a proper subset of sensing or processing capabilities; and
control the user-perceptible indicator to present a representation corresponding to the enforced capability state, wherein the apparatus is prevented from presenting a representation of a capability state unless the corresponding capability limits are enforced, and wherein the enforced capability state and the representation presented by the indicator are maintained in correspondence such that neither can change without a corresponding change in the other.

12. The apparatus of claim 11, wherein the one or more processors are configured to execute the instructions to:
record changes to the selected capability state and corresponding indicator state in a tamper-evident record; and
provide verification of at least one of a current or prior capability state to a non-owner user without providing access to sensed data.

13. The apparatus of claim 11, wherein the one or more processors are configured to execute the instructions to provide a status-only access mode for a non-owner user, wherein the status-only access mode permits the non-owner user to receive information indicating at least one of:
a current capability state of the sensing component;
attestation of an absent capability; or
a representation of the user-perceptible indicator corresponding to the current capability state, or an absent capability;
while preventing the non-owner user from accessing at least one of sensed data, recorded data, or controls that modify the capability state.

14. The apparatus of claim 13, wherein the one or more processors are configured to execute the instructions to at least one of:
provide verification of at least one of a current or prior capability state to the non-owner user; or
provide verification of an absent capability;
without providing the non-owner user access to at least one of raw sensor data, processed sensor data, stored recordings, or live feeds.

15. The apparatus of claim 14, wherein the verification of the at least one of the current or prior capability state confirms that the user-perceptible indicator corresponded to the enforced capability state at a given time.

16. The apparatus of claim 11, further comprising a transmitter configured to broadcast a wireless signal, wherein the wireless signal encodes information indicating at least one of:
a current capability state of the apparatus;
attestation of an absent capability; or
information sufficient for a remote device to request verification of the capability state or absent capability.

17. The apparatus of claim 12, wherein the one or more processors are configured to execute the instructions to:
receive a challenge message from a user device associated with the non-owner user; and
generate a response confirming at least one of the enforced capability state or an absent capability, wherein the response is generated without transmitting sensed data.

18. The apparatus of claim 17, wherein the one or more processors are configured to execute the instructions to:
based on the response, generate at least one of a visible, audible or tactile acknowledgment perceptible to the non-owner user.

19. The apparatus of claim 17, wherein the one or more processors are configured to execute the instructions to provide a preview of a sensing field, wherein the preview comprises at least one of:
obfuscated data;
masked data;
reduced-quality data;
labeled objects/events; or
partial information, wherein the partial information is sufficient to verify at least one of device placement, orientation, or field of view, and insufficient to reveal full sensed data.

20. The apparatus of claim 19, wherein provision of the preview is based on a determination that the non-owner user has permission for status-only access.
